(19) United States
(12) Patent Application Publication
(10) Pub. No.: US 2025/0209533 A1
(43) Pub. Date: Jun. 26, 2025

(54) APPLICATION OF MINIMUM FUNCTIONAL OBJECTIVES FRAMEWORK FOR UPSTREAM APPRAISAL INVESTMENT DECISIONS

(71) Applicant: Chevron U.S.A. Inc., San Ramon, CA (US)

(72) Inventors: Mauricio MORAES DAVIDOVICH, Katy, TX (US); Michael Eugene BENEFIEL, Houston, TX (US); Ellen Leah VERNOTZY, Bellaire, TX (US); Judy Lyon MOSES, Houston, TX (US); William Todd LACKEY, The Woodlands, TX (US); John Arlington BEERY, Spring, TX (US); David John KNIPPING, Cypress, TX (US); Valli Denise RIBBECK, Richmond, TX (US); Patrick Owen BURDETT, Sugar Land, TX (US); Heather Elizabeth SZABO, Houston, TX (US); Paulo Eduardo PINHEIRO ALFRADIQUE, Houston, TX (US); Jesus G. GUERRA, Houston, TX (US); Erin Margaret ENGELDER, Houston, TX (US)

(21) Appl. No.: 18/391,633

(22) Filed: Dec. 20, 2023

(51) Int. Cl. G06Q 40/06

(52) U.S. Cl. CPC G06Q 40/06

(57) ABSTRACT

A computer-implemented method for applying a minimum functional objectives (MFO) framework for upstream appraisal investment decisions can include obtaining data and characterizing a field based on the data. The computer-implemented method can also include generating an MFO objectives hierarchy based on the characterized the field. The computer-implemented method can further include determining a minimum functionality case based on the MFO objectives hierarchy. The computer-implemented method can also include analyzing an enhancement derived or not from the minimum functionality case. The computer-implemented method can include the resilience test for both MFC and enhancements. The computer-implemented method can further include assessing an appraisal value of the MFC and enhancements.

### TECHNICAL FIELD

The present application is related to oilfield analysis and, more particularly, to the application of minimum functional objectives (MFO) framework for upstream appraisal investment decisions.

### BACKGROUND

Exploration, development, and production of oil and gas fields carry high costs. The process of appraising fields for development is therefore a critical early step in the process. If an appraisal of a field is flawed, the result can be a significant loss of time and capital in trying to develop or further develop the unproductive field. This can lead to value erosion of the project.

### SUMMARY

In general, in one aspect, the disclosure relates to a computer-implemented method for applying an MFO framework for upstream appraisal investment decisions. The computer-implemented method can include obtaining data and characterizing a field based on the data. The computer-implemented method can also include generating an MFO objectives hierarchy based on characterizing the field. The computer-implemented method can further include determining a minimum functionality case based on generating the MFO objectives hierarchy. The computer-implemented method can also include analyzing an enhancement derived from the minimum functionality case. The computer-implemented method can further include identifying potential appraisal activities to learn about key project risks and uncertainties. The computer-implemented method can also include determining the lowest cost appraisal activity to the desired learning. The computer-implemented method can further include assessing an appraisal value of the enhancement.

In another aspect, the disclosure relates to an appraisal system that includes a controller that is configured to: obtain data; characterize a field based on the data; generate an MFO objectives hierarchy based on characterizing the field; determine a minimum functionality case based on generating the MFO objectives hierarchy; analyze an enhancement derived from the minimum functionality case (MFC); identify potential appraisal activities to learn about key project risks and uncertainties; determine the lowest cost appraisal activity to the desired learning; and assess an appraisal value of the enhancement.

These and other aspects, objects, features, and embodiments will be apparent from the following description and the appended claims.

### BRIEF DESCRIPTION OF THE DRAWINGS

The drawings illustrate only example embodiments and are therefore not to be considered limiting in scope, as the example embodiments may admit to other equally effective embodiments. The elements and features shown in the drawings are not necessarily to scale, emphasis instead being placed upon clearly illustrating the principles of the example embodiments. Additionally, certain dimensions or positions may be exaggerated to help visually convey such principles. In the drawings, the same reference numerals used in different figures may designate like or corresponding but not necessarily identical elements.

FIG. 1 shows a diagram of a field system according to certain example embodiments.

FIG. 2 shows a computing device in accordance with certain example embodiments.

FIG. 3 shows a flowchart of a method for applying an MFO framework for upstream appraisal investment decisions in accordance with certain example embodiments.

FIGS. 4 through 67 show various graphs and tables supporting one or more examples illustrating a step in the method of FIG. 3.

### DETAILED DESCRIPTION

The example embodiments discussed herein are directed to systems, apparatus, methods, and devices for applying an MFO framework for upstream appraisal investment decisions. Example embodiments may be used for appraising land-based subterranean fields or subsea subterranean fields. Example embodiments may be used for appraising undeveloped subterranean fields or partially developed subterranean fields.

The use of the terms “about”, “approximately”, and similar terms applies to all numeric values, whether or not explicitly indicated. These terms generally refer to a range of numbers that one of ordinary skill in the art would consider as a reasonable amount of deviation to the recited numeric values (i.e., having the equivalent function or result). For example, this term may be construed as including a deviation of ±10 percent of the given numeric value provided such a deviation does not alter the end function or result of the value. Therefore, a value of about 1% may be construed to be a range from 0.9% to 1.1%. Furthermore, a range may be construed to include the start and the end of the range. For example, a range of 10% to 20% (i.e., range of 10%-20%) includes 10% and also includes 20%, and includes percentages in between 10% and 20%, unless explicitly stated otherwise herein. Similarly, a range of between 10% and 20% (i.e., range between 10%-20%) includes 10% and also includes 20%, and includes percentages in between 10% and 20%, unless explicitly stated otherwise herein.

A “subterranean formation” refers to practically any volume under a surface. For example, it may be practically any volume under a terrestrial surface (e.g., a land surface), practically any volume under a seafloor, etc. Each subsurface volume of interest may have a variety of characteristics, such as petrophysical rock properties, reservoir fluid properties, reservoir conditions, hydrocarbon properties, or any combination thereof. For example, each subsurface volume of interest may be associated with one or more of: temperature, porosity, salinity, permeability, water composition, mineralogy, hydrocarbon type, hydrocarbon quantity, reservoir location, pressure, etc. Those of ordinary skill in the art will appreciate that the characteristics are many, including, but not limited to, shale gas, shale oil, tight gas, tight oil, tight carbonate, carbonate, vuggy carbonate, unconventional (e.g., a permeability of less than 25 millidarcy (mD) such as a permeability of from 0.000001 mD to 25 mD)), diatomite, geothermal, mineral, etc. The terms “formation”, “subsurface formation”, “hydrocarbon-bearing formation”, “reservoir”, “subsurface reservoir”, “subsurface area of interest”, “subsurface region of interest”, “subsurface volume of interest”, and the like may be used synonymously. The term “subterranean formation” is not limited to any description or configuration described herein.

A “well” or a “wellbore” refers to a single hole, usually cylindrical, that is drilled into a subsurface volume of interest. A well or a wellbore may be drilled in one or more directions. For example, a well or a wellbore may include a vertical well, a horizontal well, a deviated well, and/or other type of well. A well or a wellbore may be drilled in the subterranean formation for exploration and/or recovery of resources. A plurality of wells (e.g., tens to hundreds of wells) or a plurality of wellbores are often used in a field depending on the desired outcome.

A well or a wellbore may be drilled into a subsurface volume of interest using practically any drilling technique and equipment known in the art, such as geosteering, directional drilling, etc. Drilling the well may include using a tool, such as a drilling tool that includes a drill bit and a drill string. Drilling fluid, such as drilling mud, may be used while drilling in order to cool the drill tool and remove cuttings. Other tools may also be used while drilling or after drilling, such as measurement-while-drilling (MWD) tools, seismic-while-drilling tools, wireline tools, logging-while-drilling (LWD) tools, or other downhole tools. After drilling to a predetermined depth, the drill string and the drill bit may be removed, and then the casing, the tubing, and/or other equipment may be installed according to the design of the well. The equipment to be used in drilling the well may be dependent on the design of the well, the subterranean formation, the hydrocarbons, and/or other factors.

A well may include a plurality of components, such as, but not limited to, a casing, a liner, a tubing string, a sensor, a packer, a screen, a gravel pack, artificial lift equipment (e.g., an electric submersible pump (ESP)), and/or other components. If a well is drilled offshore, the well may include one or more of the previous components plus other offshore components, such as a riser. A well may also include equipment to control fluid flow into the well, control fluid flow out of the well, or any combination thereof. For example, a well may include a wellhead, a choke, a valve, and/or other control devices. These control devices may be located on the surface, in the subsurface (e.g., downhole in the well), or any combination thereof. In some embodiments, the same control devices may be used to control fluid flow into and out of the well. In some embodiments, different control devices may be used to control fluid flow into and out of a well. In some embodiments, the rate of flow of fluids through the well may depend on the fluid handling capacities of the surface facility that is in fluidic communication with the well. The equipment to be used in controlling fluid flow into and out of a well may be dependent on the well, the subsurface region, the surface facility, and/or other factors. Moreover, sand control equipment and/or sand monitoring equipment may also be installed (e.g., downhole and/or on the surface). A well may also include any completion hardware that is not discussed separately. The term “well” may be used synonymously with the terms “borehole,” “wellbore,” or “well bore.” The term “well” is not limited to any description or configuration described herein.

It is understood that when combinations, subsets, groups, etc. of elements are disclosed (e.g., combinations of components in a composition, or combinations of steps in a method), that while specific reference of each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

If a component of a figure is described but not expressly shown or labeled in that figure, the label used for a corresponding component in another figure may be inferred to that component. Conversely, if a component in a figure is labeled but not described, the description for such component may be substantially the same as the description for the corresponding component in another figure. The numbering scheme for the various components in the figures herein is such that each component is a three-digit number or a four-digit number, and corresponding components in other figures have the identical last two digits. For any figure shown and described herein, one or more of the components may be omitted, added, repeated, and/or substituted. Accordingly, embodiments shown in a particular figure should not be considered limited to the specific arrangements of components shown in such figure.

Further, a statement that a particular embodiment (e.g., as shown in a figure herein) does not have a particular feature or component does not mean, unless expressly stated, that such embodiment is not capable of having such feature or component. For example, for purposes of present or future claims herein, a feature or component that is described as not being included in an example embodiment shown in one or more particular drawings is capable of being included in one or more claims that correspond to such one or more particular drawings herein.

Example embodiments of applying an MFO framework for upstream appraisal investment decisions will be described more fully hereinafter with reference to the accompanying drawings, in which example embodiments of applying an MFO framework for upstream appraisal investment decisions are shown. Applying an MFO framework for upstream appraisal investment decisions may, however, be embodied in many different forms and should not be construed as limited to the example embodiments set forth herein. Rather, these example embodiments are provided so that this disclosure will be thorough and complete, and will fully convey the scope of applying an MFO framework for upstream appraisal investment decisions to those of ordinary skill in the art. Like, but not necessarily the same, elements (also sometimes called components) in the various figures are denoted by like reference numerals for consistency.

Terms such as “first”, “second”, “primary,” “secondary,” “above”, “below”, “inner”, “outer”, “distal”, “proximal”, “end”, “top”, “bottom”, “upper”, “lower”, “side”, “left”, “right”, “front”, “rear”, and “within”, when present, are used merely to distinguish one component (or part of a component or state of a component) from another. This list of terms is not exclusive. Such terms are not meant to denote a preference or a particular orientation, and they are not meant to limit embodiments of applying an MFO framework for upstream appraisal investment decisions. In the following detailed description of the example embodiments, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

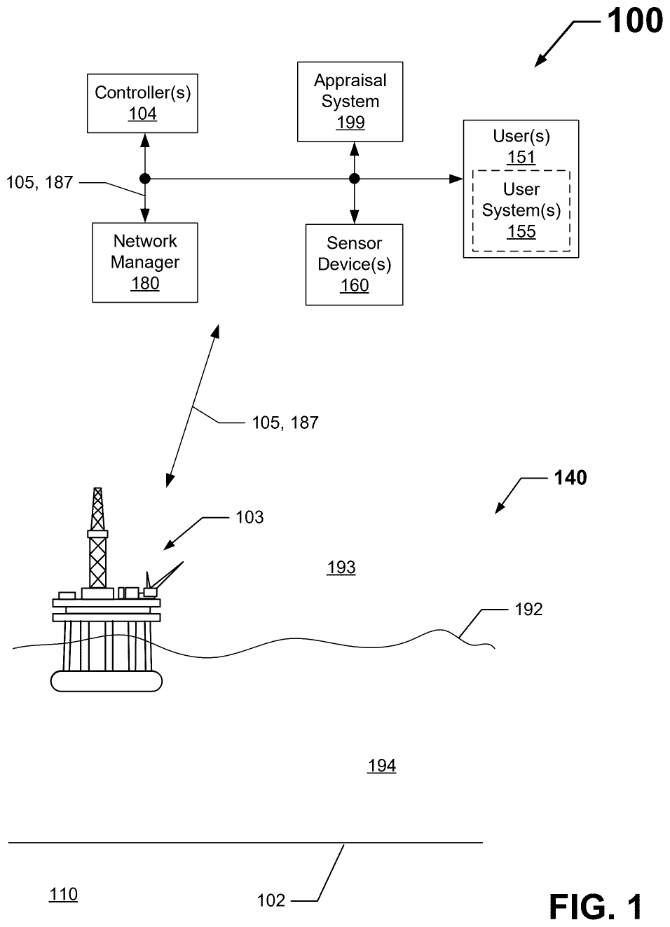

FIG. 1 shows a field system 100 according to certain example embodiments. The field system 100 in this case includes an example appraisal system 199, a network manager 180, one or more controllers 104, and one or more sensor devices 160, one or more users 151 (each having one or more user systems 155), a floating structure 103 (e.g., in the form of a drilling ship, in the form of a semi-submersible platform (as in this case)) that floats in a large and deep body of water 194, and a subterranean formation 110. The water 194, the air 193 above the water line 192, and/or the subterranean formation 110 can be considered part of the field 140 being appraised. The components shown in FIG. 1 are not exhaustive, and in some embodiments, one or more of the components shown in FIG. 1 may not be included in the field system 100. Any component of the field system 100 may be discrete or combined with one or more other components of the subsea field system 100. Also, one or more components of the field system 100 may have different configurations.

For example, a controller 104, rather than being a stand-alone device, may be part of one or more other components (e.g., the appraisal system 199) of the field system 100. As another example, in alternative embodiments, the structure 103 is not floating, but instead is a type of rig (e.g., a jack-up rig) that has one or more legs that rest on the seabed 102 (also sometimes called the subsea floor herein). In yet other alternative embodiments, there is no water 194, no floating structure 103, and/or any other type of structure (e.g., a jack-up rig, a building (e.g., a trailer) or series of buildings). The appraisal performed using the example appraisal system 199 includes the process of evaluating the field 140 for subterranean field operations in which well construction (e.g., drilling) and production phases (also called stages) can be executed to drill a wellbore and subsequently extract one or more subterranean resources (e.g., oil, natural gas, water, hydrogen gas) from and/or inject resources (e.g., carbon monoxide, carbon dioxide, water) into the subterranean formation 110 via a wellbore. In some cases, a subterranean field operation involves multiple wellbores that originate from the same proximate location (sometimes called a pad) on the seabed 102 (or ground surface for a field system 100 that is land based). In such cases, the wellbores are drilled one at a time.

In some cases, the example appraisal system 199, one or more of the users 151 (including the associated user systems 155), one or more of the controllers 104, one or more of the sensor devices 160, and/or the network manager 180, or portions thereof, may be located on the topsides of the floating structure 103, a non-floating structure in the water 194, or a land-based structure. In addition, or in the alternative, the example appraisal system 199, one or more users 151 (including any associated user system 155), one or more controllers 104, one or more of the sensor devices 160, and/or the network manager 180, or portions thereof, may be located elsewhere (e.g., in an office building on land, in the water 194).

A user 151 may be any person that interacts, directly or indirectly, with the example appraisal system 199 and/or any other component of the field system 100. Examples of a user 151 may include, but are not limited to, a business owner, an engineer, a company representative, a geologist, a consultant, a contractor, and a manufacturer's representative. A user 151 may use one or more user systems 155, which may include a display (e.g., a GUI). A user system 155 of a user 151 may interact with (e.g., send data to, obtain data from) the example appraisal system 199, a controller 104, the network manager 180, a sensor device 160, and/or any other component of the field system 100 via an application interface and using the communication links 105 (discussed below). The user 151 may also interact directly with the example appraisal system 199, a controller 104, the network manager 180, a sensor device 160, and/or any other component of the field system 100 through a user interface (e.g., keyboard, mouse, touchscreen).

A user system 155 of a user 151 may interact with (e.g., sends data to, receives data from) the example appraisal system 199 via an application interface. Examples of a user system 155 may include, but are not limited to, a cell phone with an app, a laptop computer, a handheld device, a smart watch, a desktop computer, and an electronic tablet. In some cases, a user 151 (including an associated user system 155) may also interact directly with the network manager 180, one or more of the controllers 104, the example appraisal system 199, one or more of the sensor devices 160, and/or any other components in the field system 100 using one or more communication links 105.

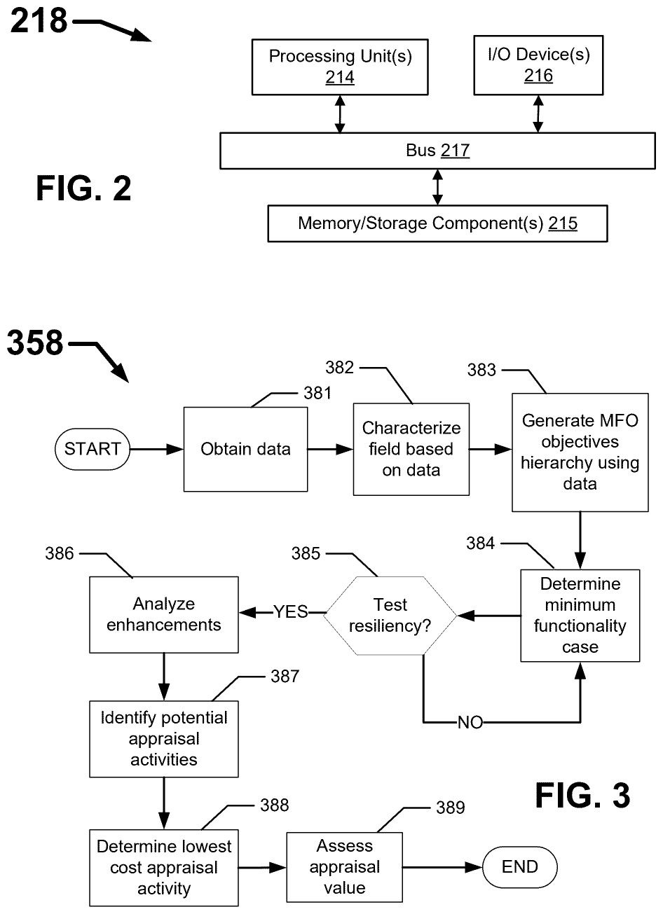

The network manager 180 is a device or component that controls all or a portion (e.g., a communication network, a controller 104, the example appraisal system 199) of the field system 100. The network manager 180 may be substantially similar to a controller 104 and/or some or all of the example appraisal system 199. For example, the network manager 180 may include a controller that has one or more components and/or similar functionality to some or all of a controller 104. Alternatively, the network manager 180 may include one or more of a number of features in addition to, or altered from, the features of a controller 104. As described herein, control and/or communication with the network manager 180 may include communicating with one or more other components of the same field system 100 or another system. In such a case, the network manager 180 may facilitate such control and/or communication. The network manager 180 may be called by other names, including but not limited to a master controller, a network controller, and an enterprise manager. The network manager 180 may be considered a type of computer device, as discussed below with respect to FIG. 2.

As mentioned above, the field system 100 may include one or more controllers 104. Each controller 104 may be communicably coupled to the network manager 180. A controller 104 may also be communicably coupled to one or more other components of the field system 100, including but not limited to the example appraisal system 199, a user 151 (including an associated user system 155), and one or more sensor devices 160. A controller 104 may perform a number of functions that may include obtaining and sending data, evaluating data, following protocols, running algorithms, and sending commands. A controller 104 may include one or more of a number of components.

A controller 104 of FIG. 1 may include one or more components. Examples of components of a controller 104 may include, but are not limited to, a control engine, a communication module, a timer, a counter, a power module, a storage repository, a hardware processor, memory, a transceiver, an application interface, and a security module. When there are multiple controllers 104, each controller 104 may operate independently of each other. Alternatively, one or more of the controllers 104 may work cooperatively with each other. As yet another alternative, one of the controllers 104 may control some or all of one or more other controllers 104 in the field system 100. As still another alternative, each controller 104 may be in communication with and controlled by a controller of the example appraisal system 199. Each controller 104 may be considered a type of computer device, as discussed below with respect to FIG. 2.

Each sensor device 160 of the field system 100 includes one or more sensors that measure one or more parameters (e.g., pressure, flow rate, temperature, humidity, fluid content, voltage, current, presence of an object or component, chemical elements in a fluid, vibrations, movement, subsea current, metocean data). Examples of a sensor of a sensor device 160 may include, but are not limited to, a seismic sensor, a nuclear magnetic resonance (NMR) sensor, a temperature sensor, a flow sensor, a pressure sensor, a proximity sensor, a gas spectrometer, a vibration sensor, an accelerometer, an infrared transceiver, a voltmeter, an ammeter, a permeability meter, a porosimeter, and a camera. A sensor device 160 may be integrated with or measure a parameter associated with one or more components of the field system 100. For example, a sensor device 160 may be configured to measure a parameter (e.g., porosity, permeability, pressure, temperature, presence of a subterranean resource) associated with the field 140.

In certain example embodiments, a sensor device 160 can be a type of sensor device (e.g., a NMR device, a seismograph, LIDAR) used in the current art for appraising a field (e.g., field 140). In some cases, a number of sensor devices 160, each measuring a different parameter, may be used in combination to determine and confirm whether a controller 104 (including a controller of the appraisal system 199) should take a particular action (e.g., operate a valve, operate or adjust the operation of a pump, send a notification, run a model). When a sensor device 160 includes its own controller (e.g., a controller 104), or portions thereof, then the sensor device 160 may be considered a type of computer device, as discussed below with respect to FIG. 2.

The example appraisal system 199 of the field system 100 is configured to perform an appraisal of the field 140. For example, the example appraisal system 199 may apply an MFO mindset to appraisal planning and evaluation of the field 140. The example appraisal system 199 may provide a capital efficient, objectives-led appraisal program to acquire the information needed to inform the development decision of the field 140. The example appraisal system 199 may perform one or more of a number of functions or steps, including but not limited to characterizing the opportunity, completing an MFO objectives hierarchy, finding the minimum functionality case, analyzing enhancements, testing resilience, and assessing an appraisal value. An output of the example appraisal system 199 may be a valuation of risk, a list of trade-offs, and/or an economic impact of certain decisions or scenarios relative to conducting field operations on the field 140. A goal of the appraisal system 199 is not to eliminate uncertainty, but is rather to enable decisions that are robust in the presence of uncertainty.

The example appraisal system 199 may be or include one or more controllers, which can be similar to a controller 104 discussed above. For example, a controller of the example appraisal system 199 may include one or more components, including but not limited to a control engine, a communication module, a timer, a counter, a power module, a storage repository, a hardware processor, memory, a transceiver, an application interface, and a security module. Each controller of the example appraisal system 199 may be considered a type of computer device, as discussed below with respect to FIG. 2. In addition, or in the alternative, the example appraisal system 199 may include one or more sensor devices, which can be similar to a sensor device 160 discussed above.

Communication between the network manager 180, the users 151 (including any associated user systems 155), the controllers 104, the sensor devices 160, the example appraisal system 199 (including portions thereof, as discussed below), and any other components of the field system 100 may be facilitated using the communication links 105. Each communication link 105 may include wired (e.g., Class 1 electrical cables, electrical connectors, Power Line Carrier, RS485) and/or wireless (e.g., sound or pressure waves in the water 194, Wi-Fi, Zigbee, visible light communication, cellular networking, Bluetooth, Bluetooth Low Energy (BLE), ultrawide band (UWB), WirelessHART, ISA100) technology.

Similarly, the transfer of power between any two components (e.g., a controller 104 and a sensor device 160) of the field system 100 may be facilitated using power transfer links 187. Each power transfer link 187 may include one or more electrical conductors, which may be individual or part of one or more electrical cables. In some cases, as with inductive power, power may be transferred wirelessly using power transfer links 187. A power transfer link 187 may transmit power from one component of the field system 100 to another. Each power transfer link 187 may be sized (e.g., 12 gauge, 18 gauge, 4 gauge) in a manner suitable for the amount (e.g., 480V, 24V, 120V) and type (e.g., alternating current, direct current) of power transferred therethrough.

FIG. 2 illustrates one embodiment of a computing device 218 that implements one or more of the various techniques described herein, and which is representative, in whole or in part, of the elements described herein pursuant to certain example embodiments. For example, a controller (including components thereof, such as a control engine, a hardware processor, a storage repository, a power module, and a transceiver) of the example appraisal system 199 may be considered a computing device 218. Computing device 218 is one example of a computing device and is not intended to suggest any limitation as to scope of use or functionality of the computing device and/or its possible architectures. Neither should the computing device 218 be interpreted as having any dependency or requirement relating to any one or combination of components illustrated in the example computing device 218.

The computing device 218 includes one or more processors or processing units 214, one or more memory/storage components 215, one or more input/output (I/O) devices 216, and a bus 217 that allows the various components and devices to communicate with one another. The bus 217 represents one or more of any of several types of bus structures, including a memory bus or memory controller, a peripheral bus, an accelerated graphics port, and a processor or local bus using any of a variety of bus architectures. The bus 217 includes wired and/or wireless buses.

The memory/storage component 215 represents one or more computer storage media. The memory/storage component 215 includes volatile media (such as random access memory (RAM)) and/or nonvolatile media (such as read only memory (ROM), flash memory, optical disks, magnetic disks, and so forth). The memory/storage component 215 includes fixed media (e.g., RAM, ROM, a fixed hard drive, etc.) as well as removable media (e.g., a Flash memory drive, a removable hard drive, an optical disk, and so forth).

One or more I/O devices 216 allow a user 151 to enter commands and information to the computing device 218, and also allow information to be presented to the user 151 and/or other components or devices. Examples of input devices 216 include, but are not limited to, a keyboard, a cursor control device (e.g., a mouse), a microphone, a touchscreen, and a scanner. Examples of output devices include, but are not limited to, a display device (e.g., a monitor or projector), speakers, outputs to a lighting network (e.g., DMX card), a printer, and a network card.

Various techniques are described herein in the general context of software or program modules. Generally, software includes routines, programs, objects, components, data structures, and so forth that perform particular tasks or implement particular abstract data types. An implementation of these modules and techniques are stored on or transmitted across some form of computer readable media. Computer readable media is any available non-transitory medium or non-transitory media that is accessible by a computing device. By way of example, and not limitation, computer readable media includes “computer storage media”.

“Computer storage media” and “computer readable medium” include volatile and non-volatile, removable and non-removable media implemented in any method or technology for storage of information such as computer readable instructions, data structures, program modules, or other data. Computer storage media include, but are not limited to, computer recordable media such as RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which is used to store the desired information and which is accessible by a computer.

The computer device 218 (also sometimes called a computer system 218 herein) is connected to a network (not shown) (e.g., a LAN, a WAN such as the Internet, cloud, or any other similar type of network) via a network interface connection (not shown) according to some example embodiments. Those skilled in the art will appreciate that many different types of computer systems exist (e.g., desktop computer, a laptop computer, a personal media device, a mobile device, such as a cell phone or personal digital assistant, or any other computing system capable of executing computer readable instructions), and the aforementioned input and output means take other forms, now known or later developed, in other example embodiments. Generally speaking, the computer system 218 includes at least the minimal processing, input, and/or output means necessary to practice one or more embodiments.

Further, those skilled in the art will appreciate that one or more elements of the aforementioned computer device 218 is located at a remote location and connected to the other elements over a network in certain example embodiments. Further, one or more embodiments are implemented on a distributed system having one or more nodes, where each portion of the implementation (e.g., the appraisal system 199) is located on a different node within the distributed system. In one or more embodiments, the node corresponds to a computer system. Alternatively, the node corresponds to a processor with associated physical memory in some example embodiments. The node alternatively corresponds to a processor with shared memory and/or resources in some example embodiments.

FIG. 3 shows a flowchart 358 of a method for applying an MFO framework for upstream appraisal investment decisions according to certain example embodiments. While the various steps in this flowchart 358 are presented sequentially, one of ordinary skill will appreciate that some or all of the steps may be executed in different orders, may be combined or omitted, and some or all of the steps may be executed in parallel. Further, in one or more of the example embodiments, one or more of the steps shown in this example method may be omitted, repeated, and/or performed in a different order. Some or all of the steps of the method of FIG. 3 may be performed off site (e.g., in a laboratory remote from a subterranean formation being evaluated). In addition, or in the alternative, some or all of the steps of the method of FIG. 3 may be performed on site where a subterranean formation is being evaluated.

In addition, a person of ordinary skill in the art will appreciate that additional steps not shown in FIG. 3 may be included in performing this method. Accordingly, the specific arrangement of steps should not be construed as limiting the scope. Further, a particular computing device, such as the computing device 218 discussed above with respect to FIG. 2, may be used to perform or facilitate performance of one or more of the steps for the method shown in FIG. 3 in certain example embodiments. Any of the functions performed below by a controller (e.g., a controller 104, a controller of an example appraisal system 199) may involve the use of one or more protocols, one or more algorithms, and/or stored data stored in a storage repository, any or all of which may be part of the controller. In addition, or in the alternative, any of the functions in the method may be performed by a user (e.g., user 151).

The method shown in FIG. 3 is merely an example that may be performed by using an example system described herein. In other words, systems for applying an MFO framework for upstream appraisal investment decisions may perform other functions using other methods in addition to and/or aside from those shown in FIG. 3. Referring to FIGS. 1 through 3, the method shown in the flowchart 358 of FIG. 3 begins at the START step and proceeds to step 381, where data is obtained. As used herein, the term “obtaining” may include receiving, retrieving, accessing, generating, etc. or any other manner of obtaining the data. The data may be obtained by the example appraisal system 199 (or portion thereof) from one or more of the sensor devices 160. The data may be associated with the field 140 being evaluated.

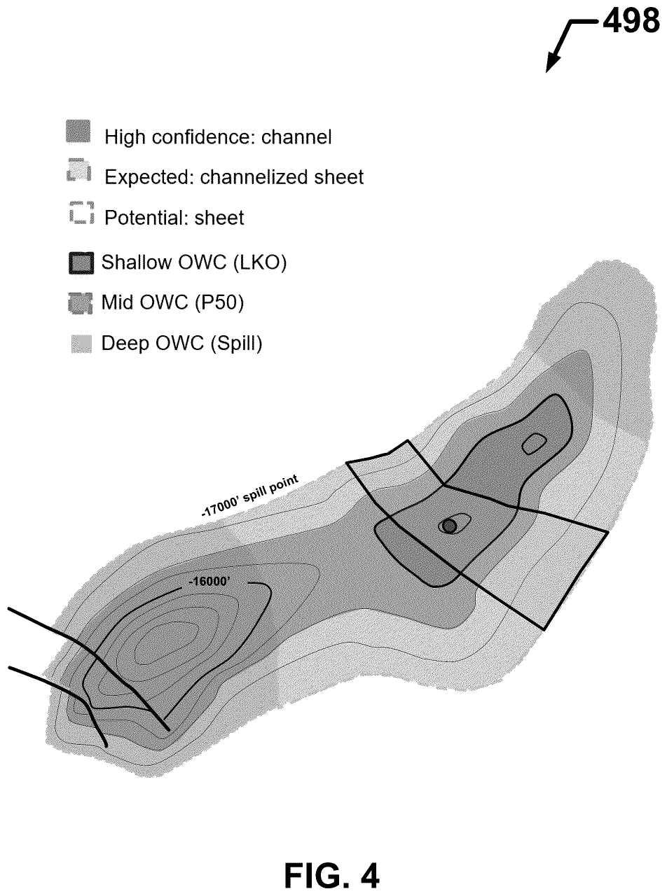

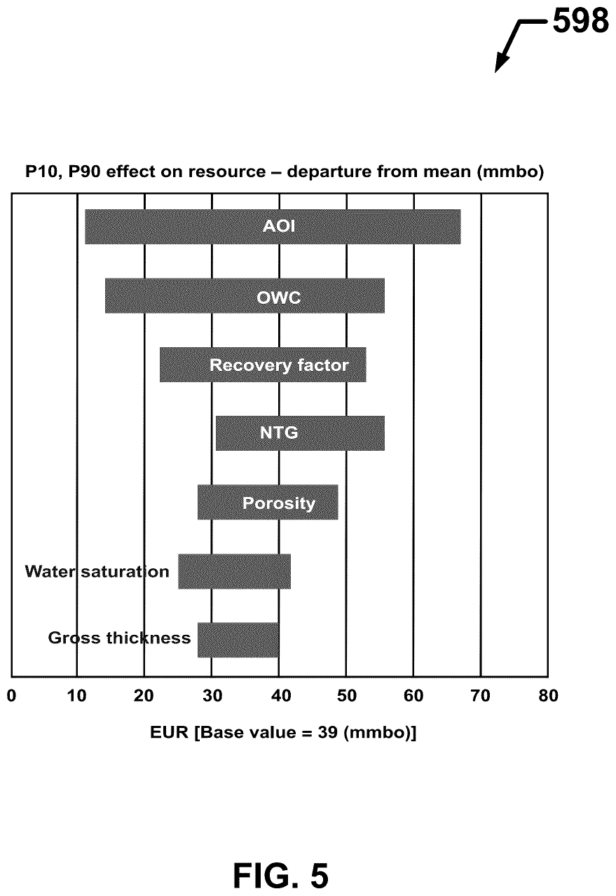

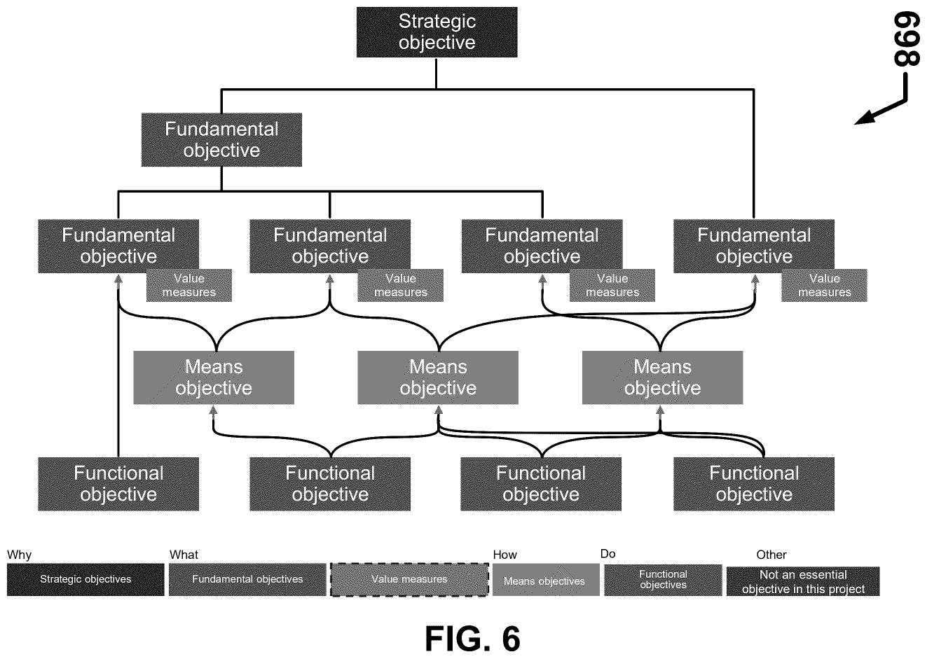

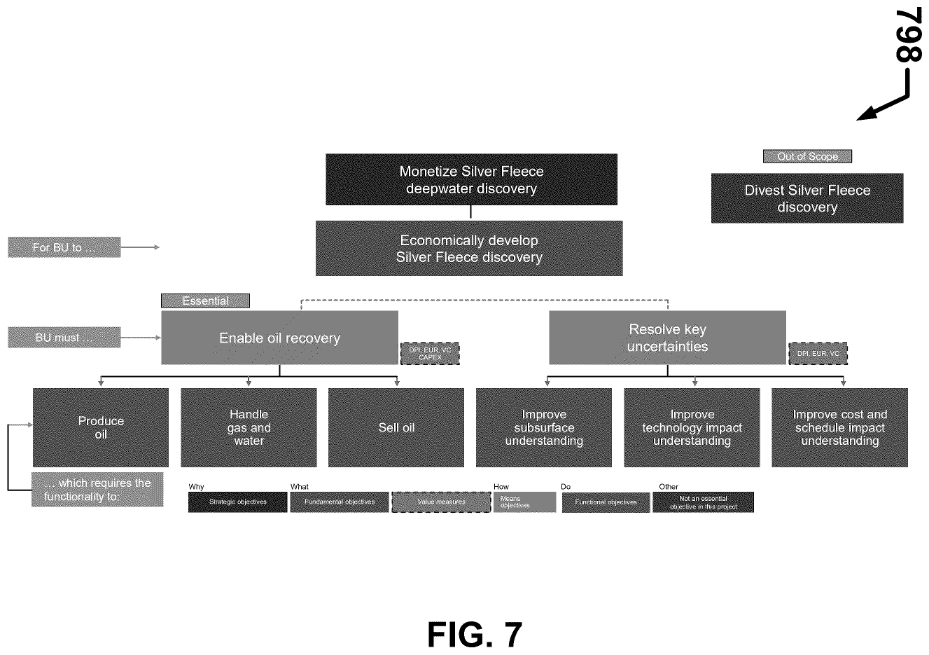

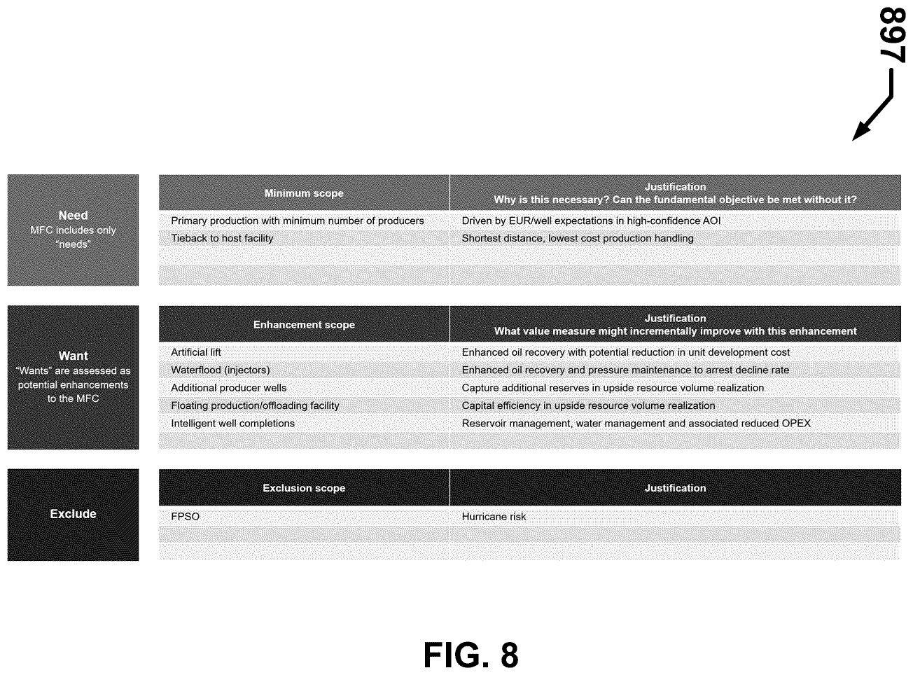

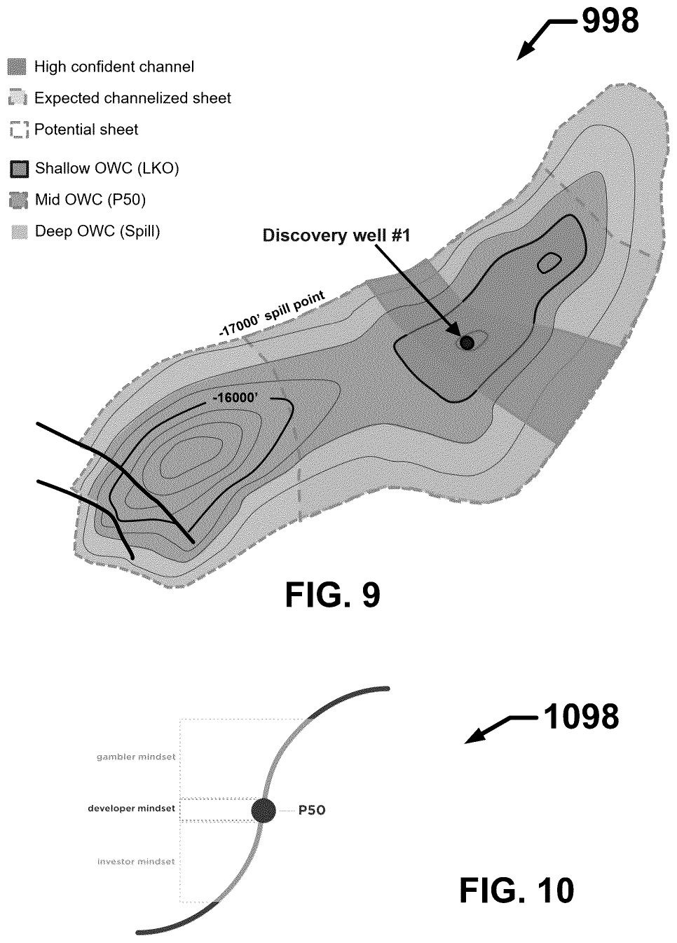

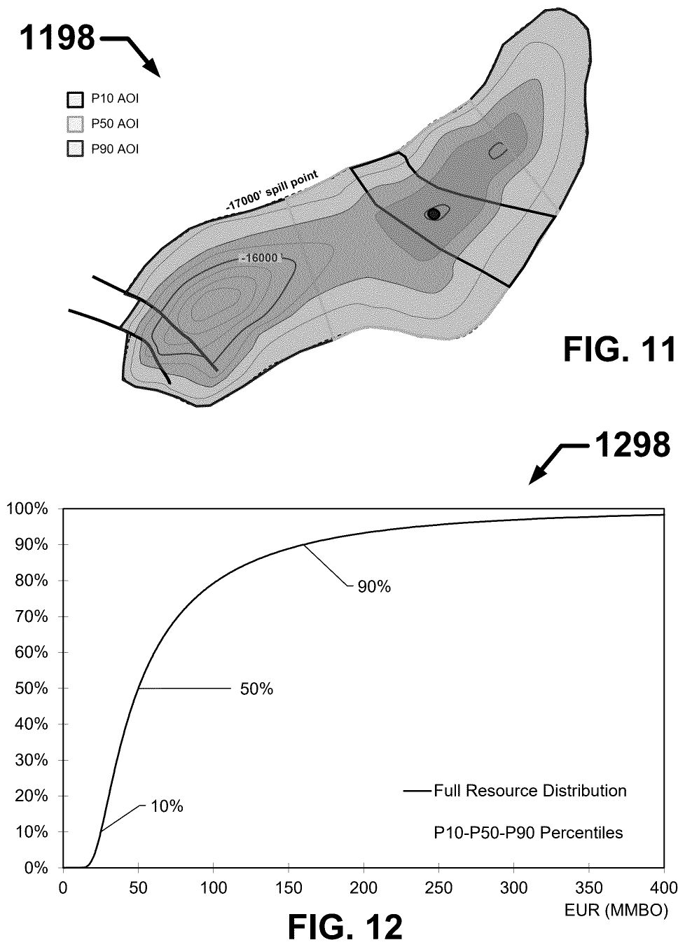

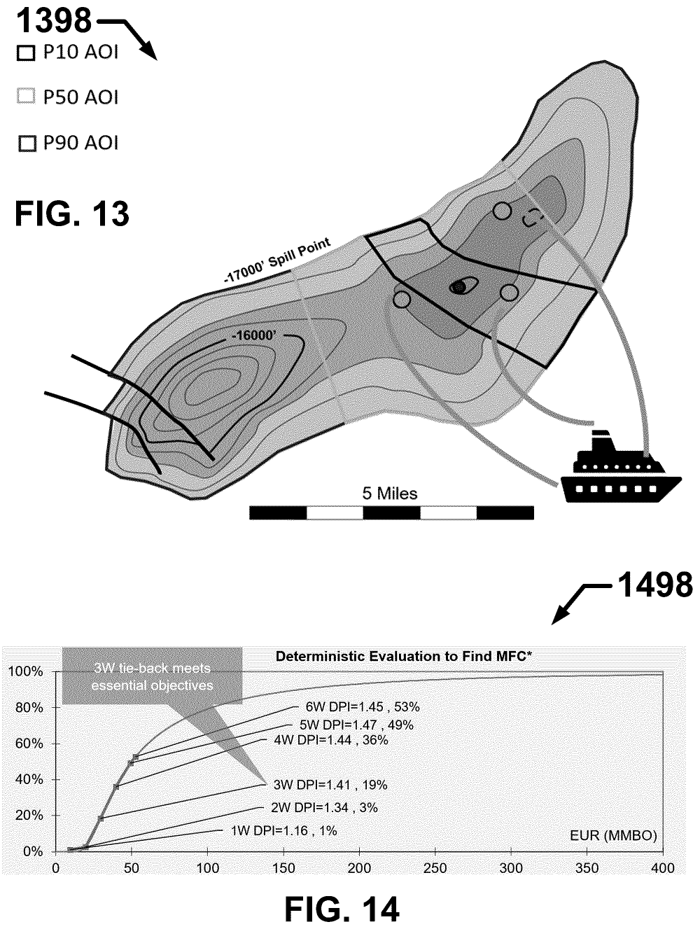

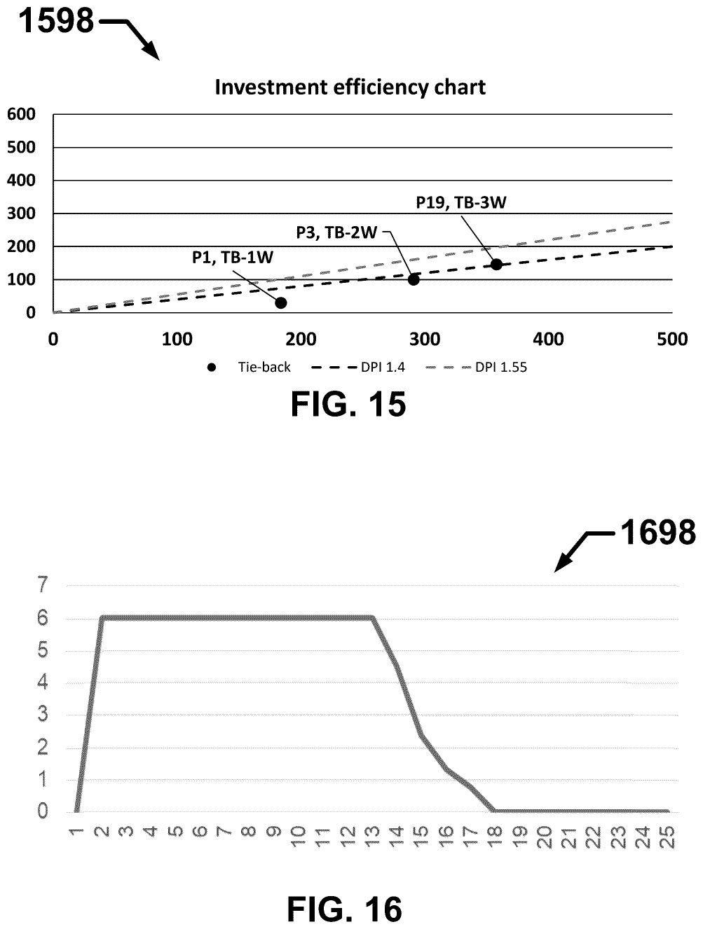

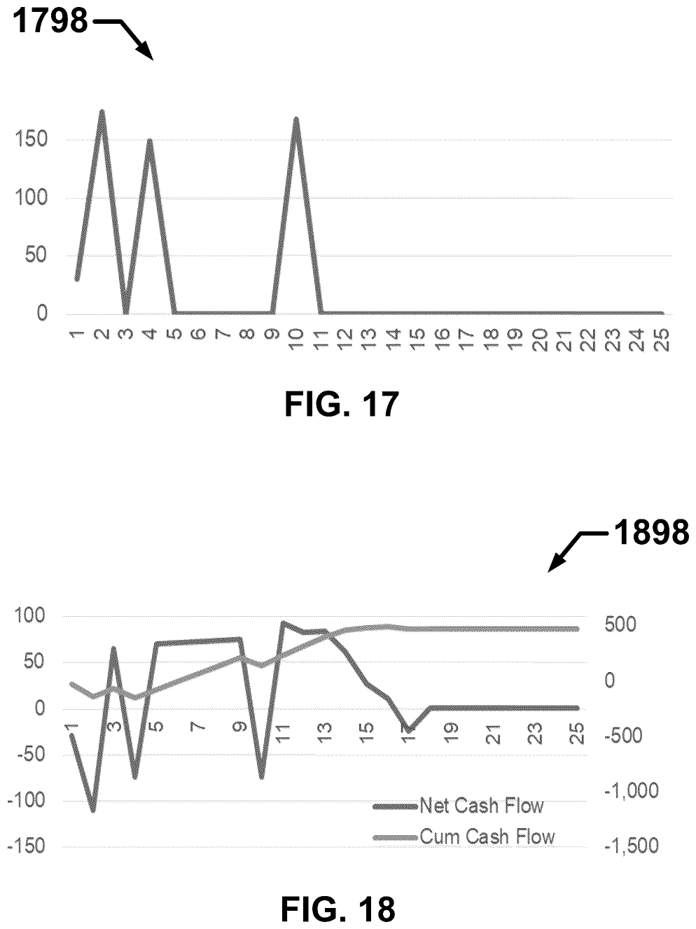

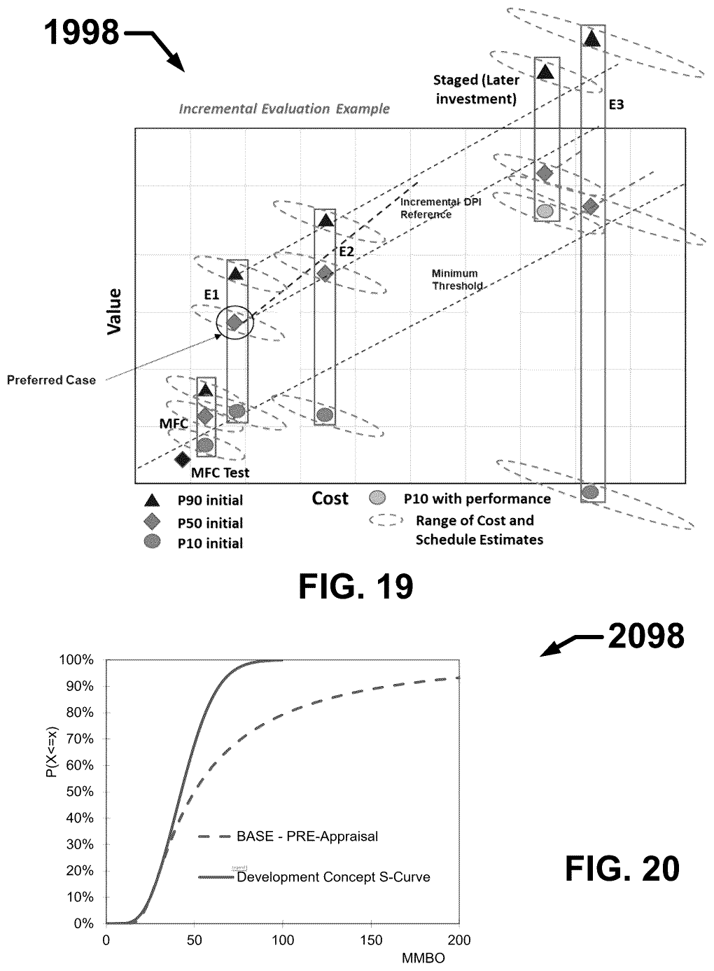

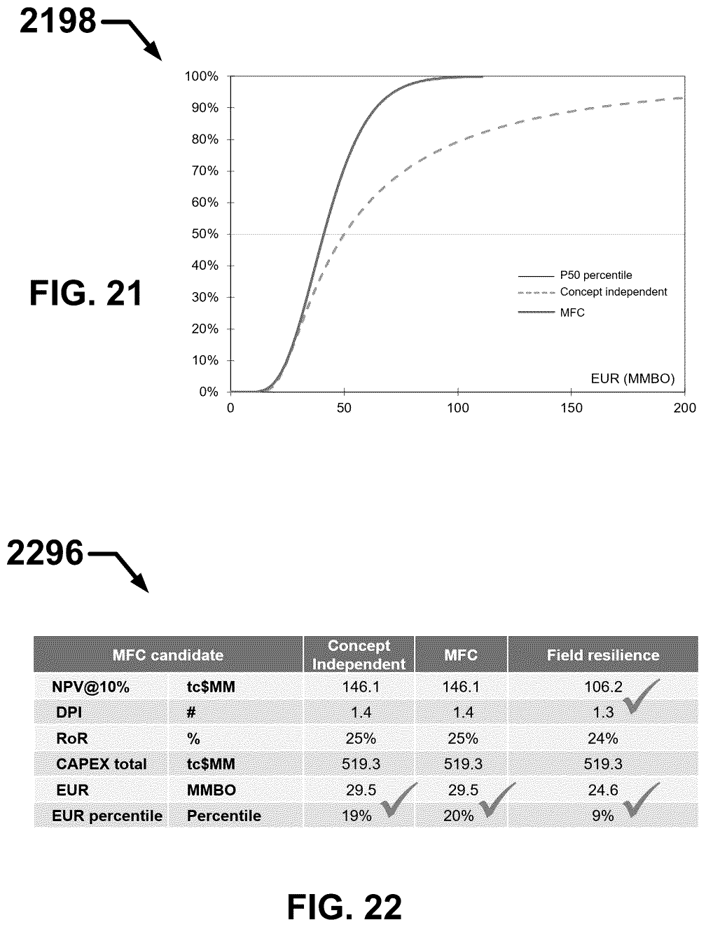

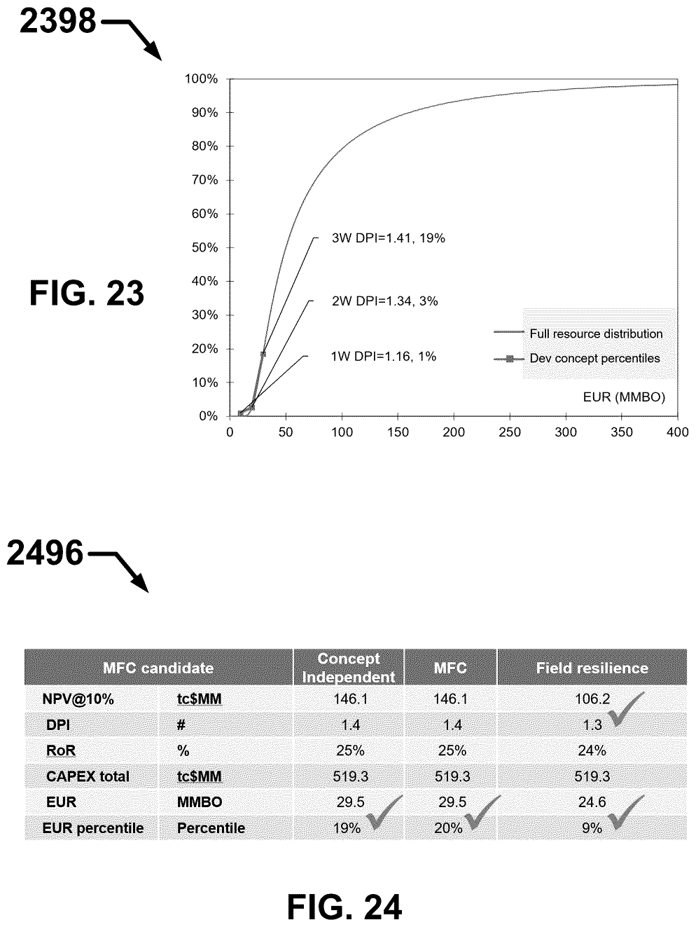

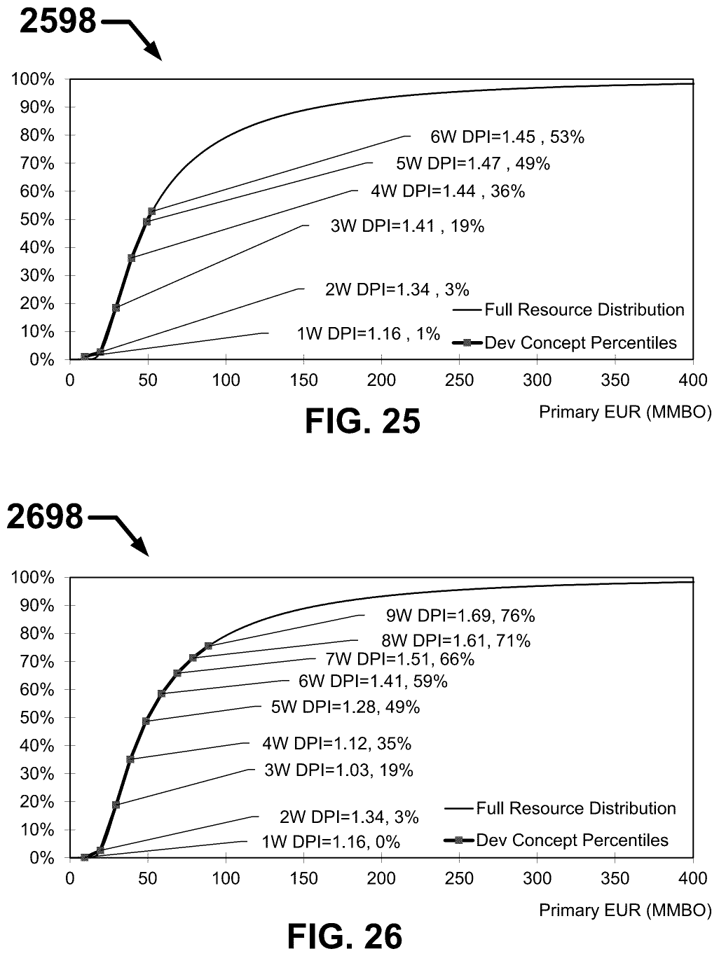

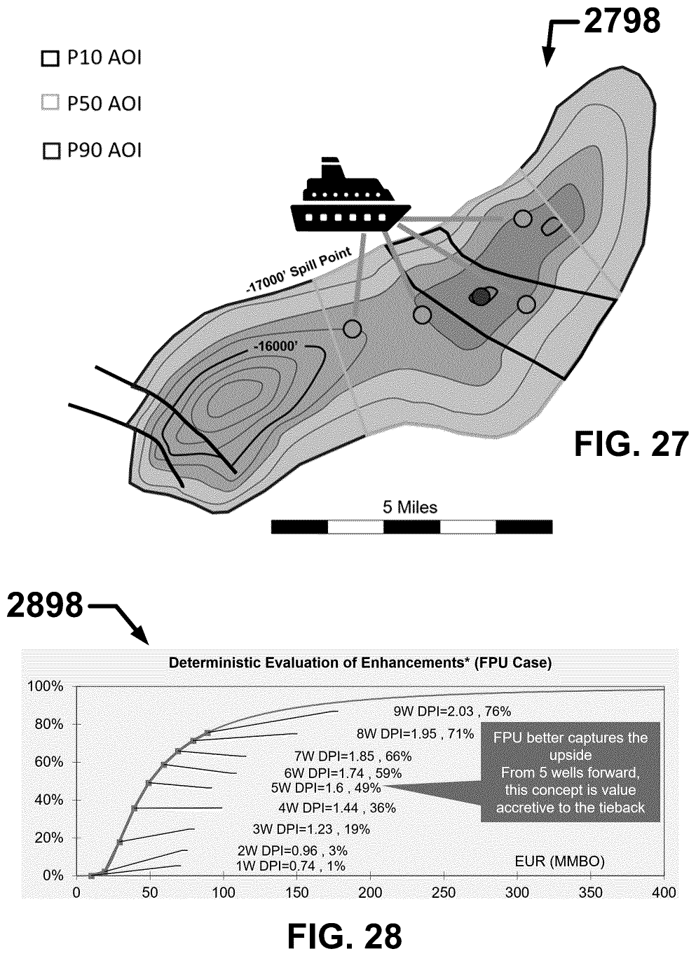

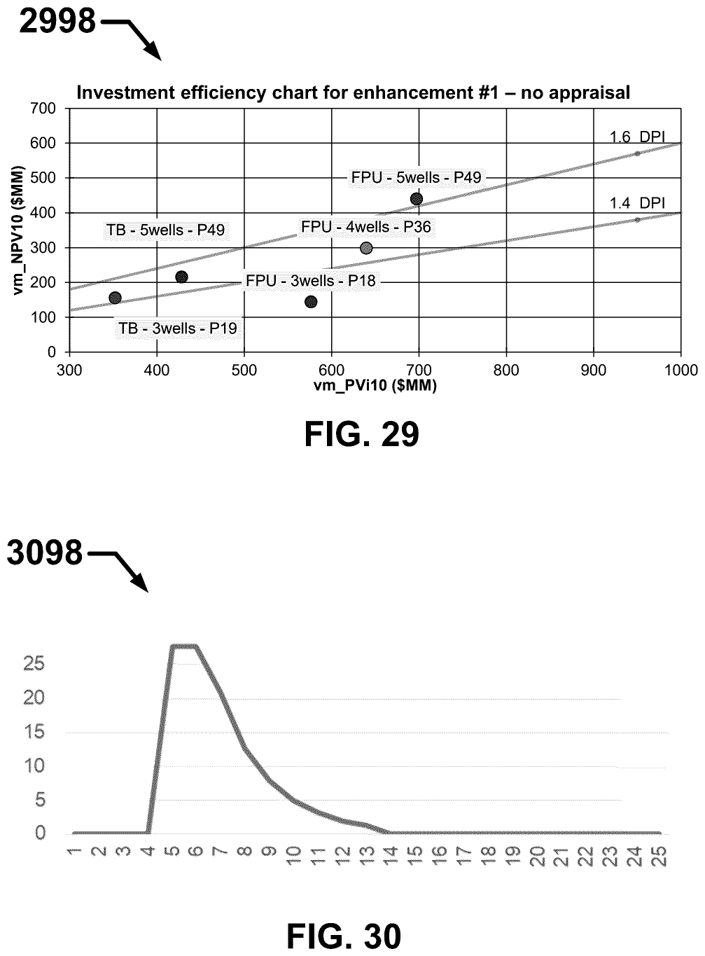

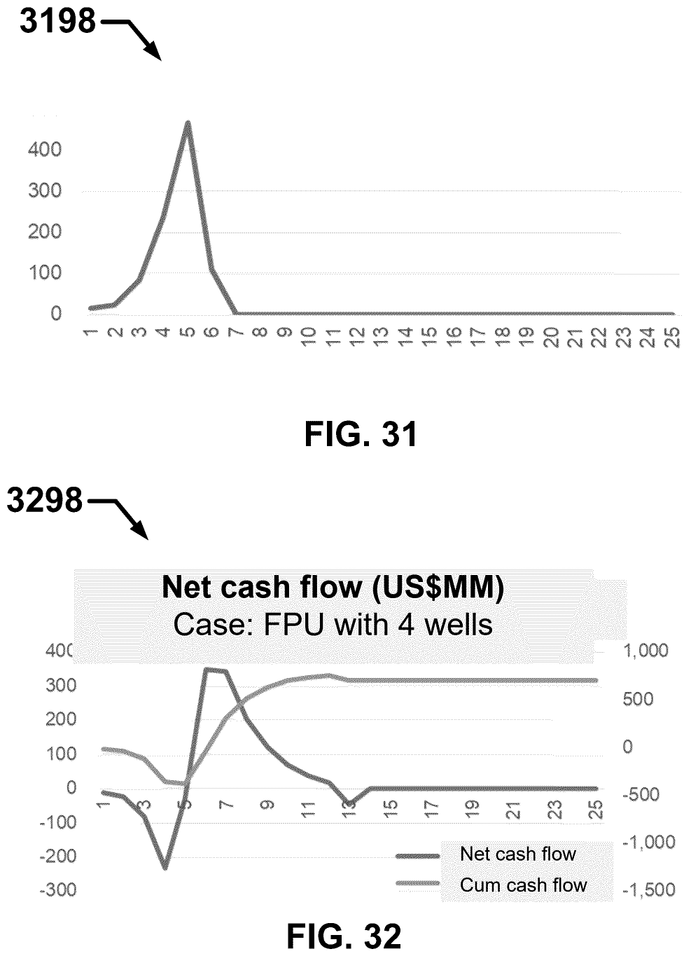

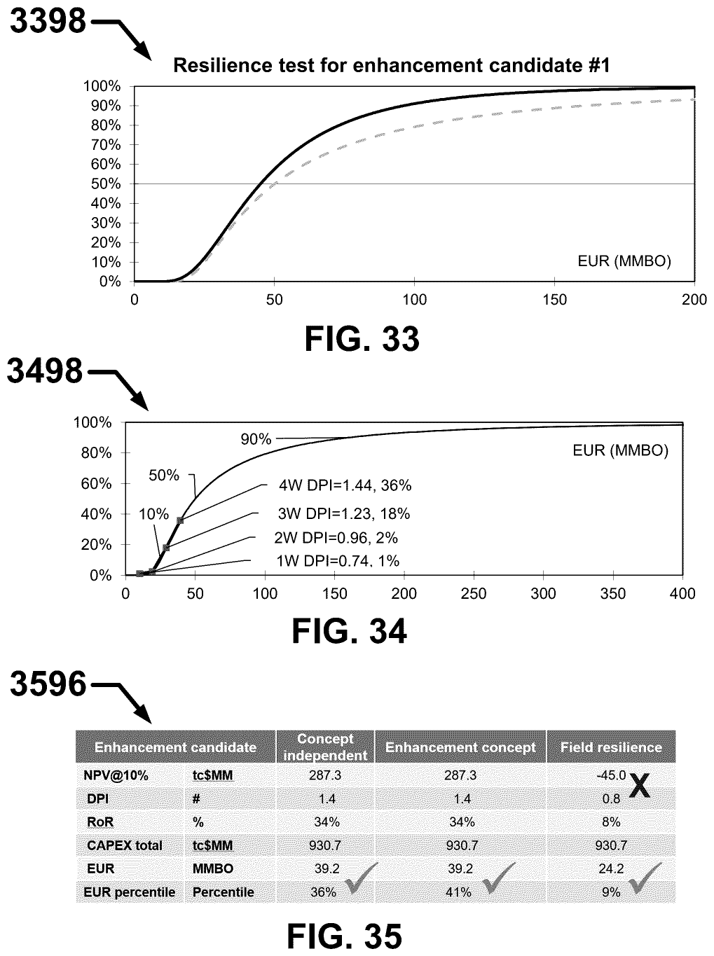

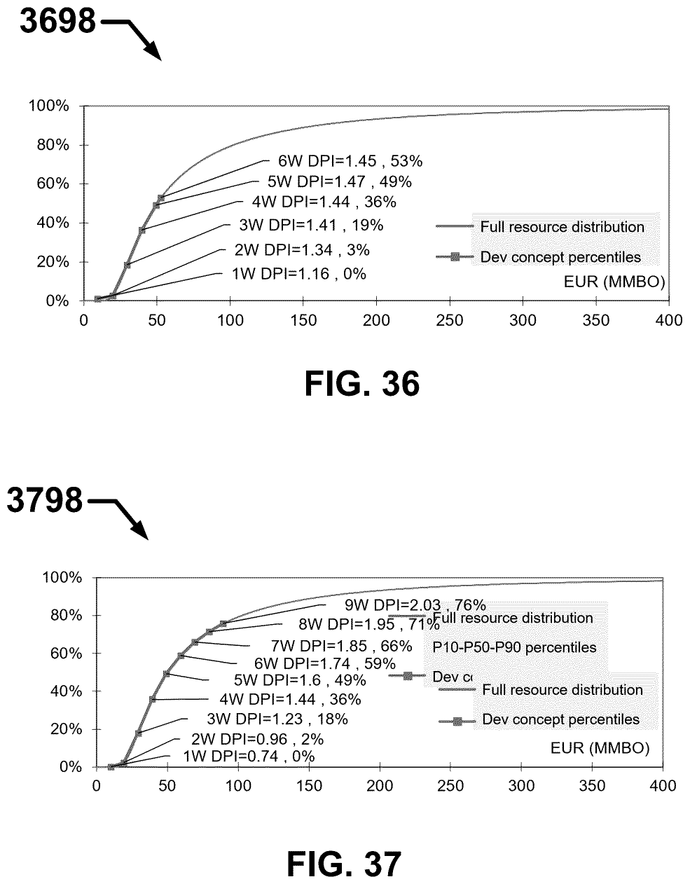

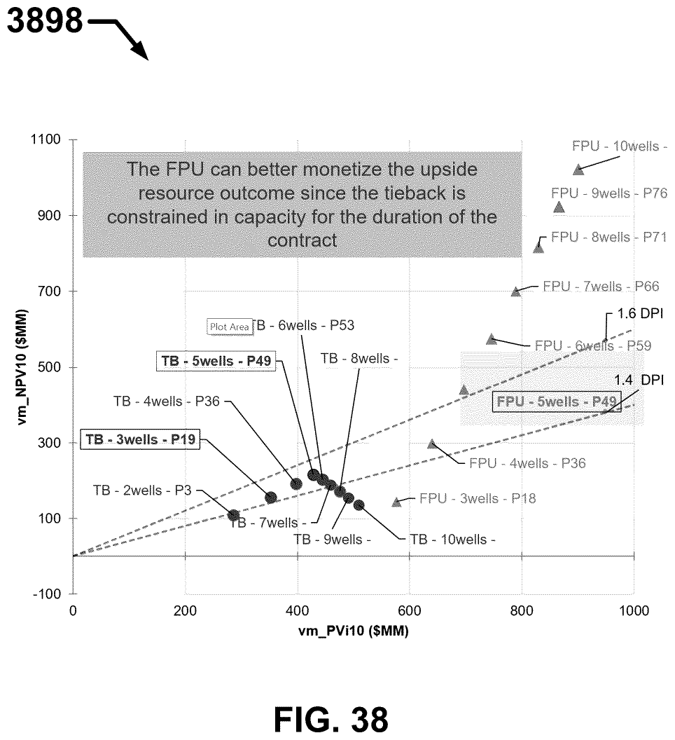

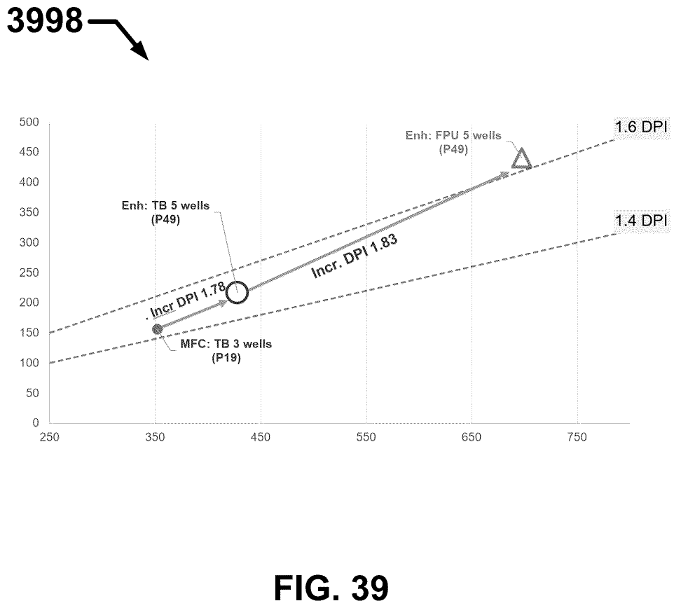

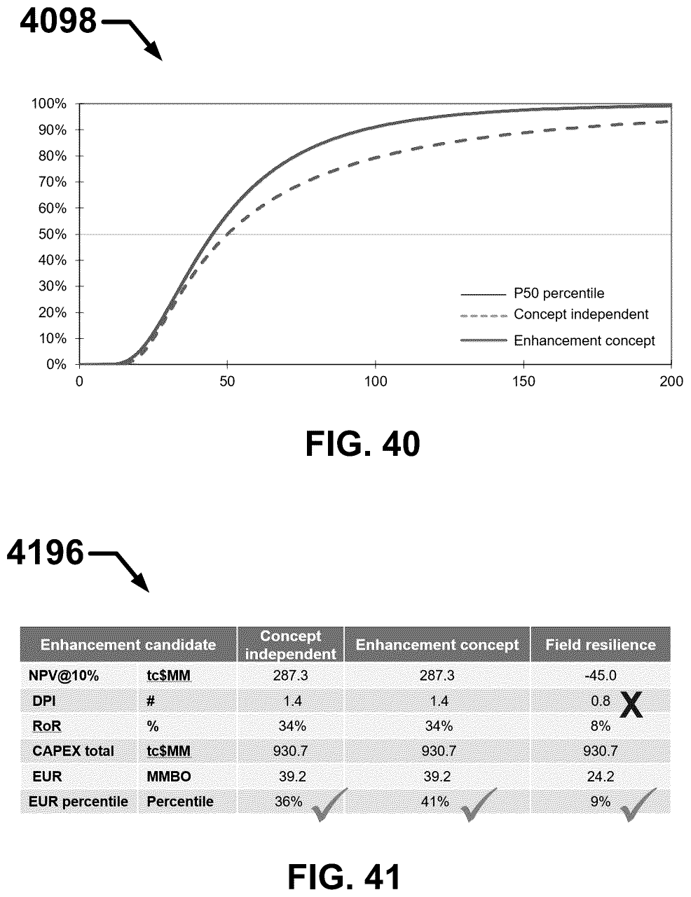

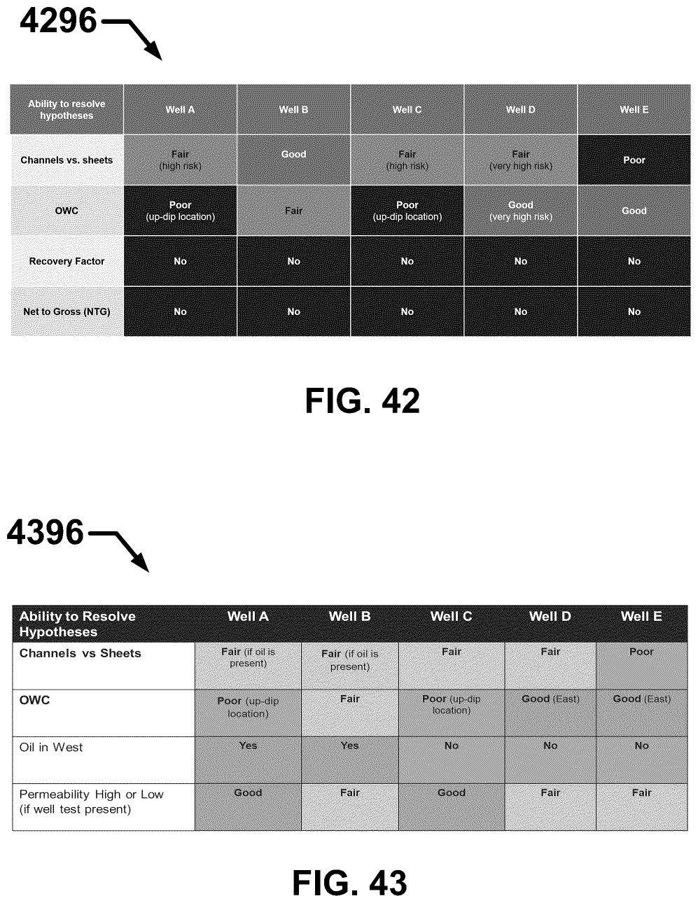

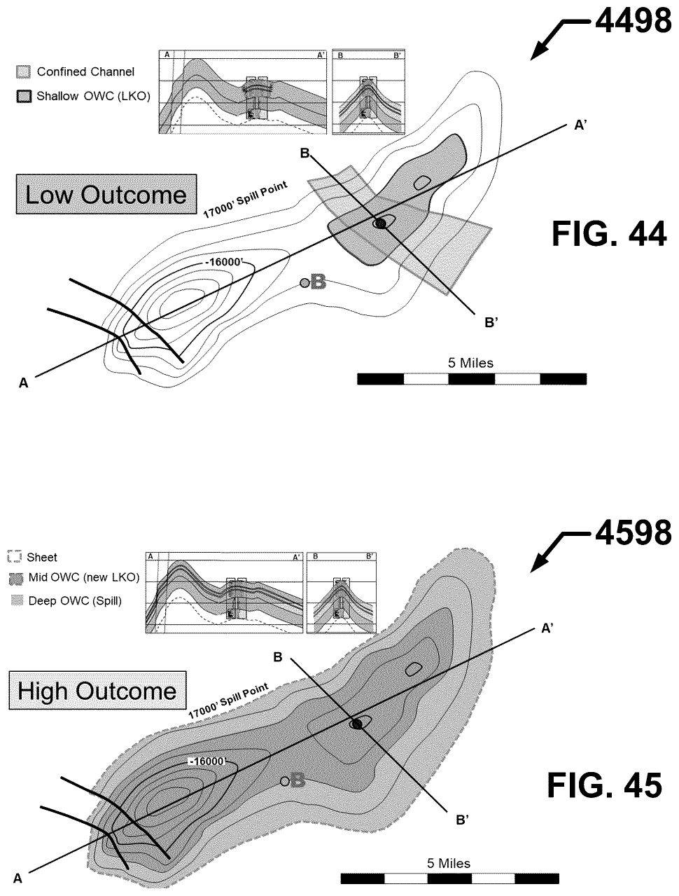

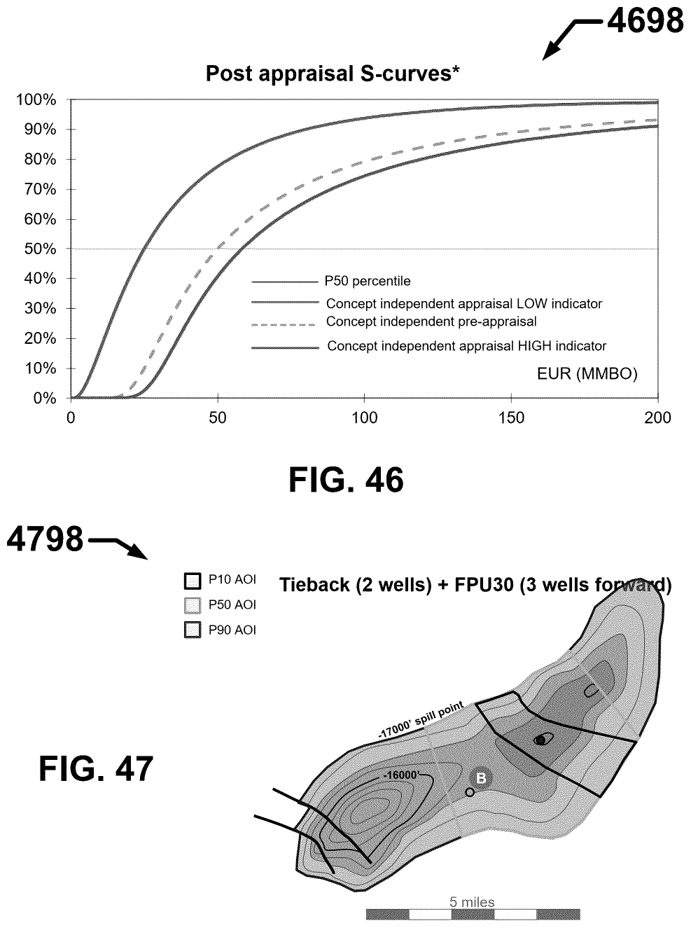

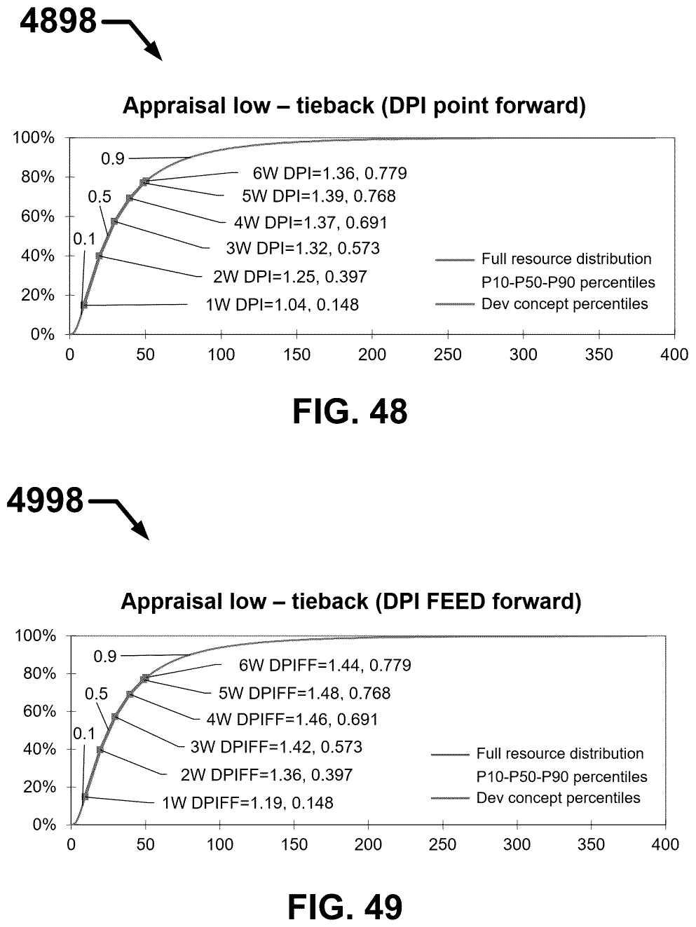

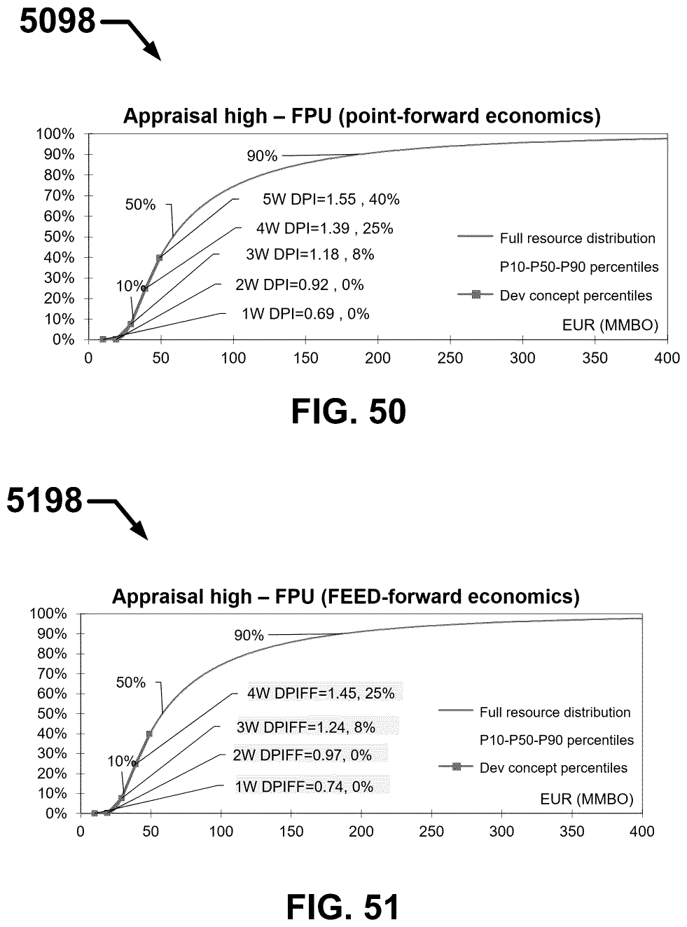

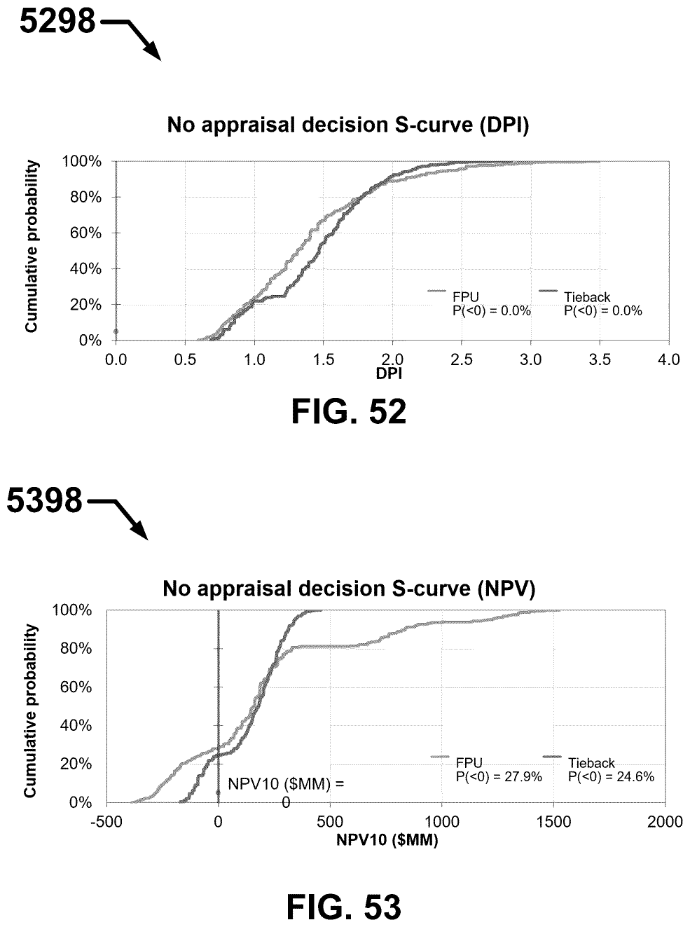

In step 382, the field 140 is characterized based on the data. FIG. 4 shows a graph 498 illustrating an example of how the field 140 can be characterized based on the data. Specifically, the graph 498 of FIG. 4 shows a sectional plot of part of a subterranean formation 110 with approximately 420 feet of net oil sands over a 700 foot gross interval. A sensor device 160 in the form of a seismograph yields good quality data that is obtained by the example appraisal system 199 in step 381 above. Effective images of structural features of the field 140 are shown. Sand presence and net-to-gross (NTG) of the depositional system is uncertain. Seismic and analog data indicate no compartmentalization from faulting. Basic wireline logs and sidewall cores may be collected from an adjacent wellbore in the subterranean formation 110 as part of the data obtained in step 381. Wireline formation test (WFT) pressure data collected from the adjacent wellbore suggests a high likelihood of gross interval being vertically connected (e.g., MDT, RDT). WFT gradient interpretation using pressures from underlying wet sand suggests oil water contact (OWC) deeper than the logged lowest-known-oil (LKO). Understanding subsurface risks and uncertainties may be important to understanding where to focus and evaluate value of appraisal. Other variables outside of subsurface may also be relevant (e.g., commercial terms, contract terms, fiscal terms, costs).

FIG. 5 shows a graph 598 in the form of a tornado chart further illustrating an example of how the field 140 can be characterized based on the data. Specifically, the graph 598 of FIG. 5 shows ranges of resource uncertainties that can impact the value of information of the appraisal activity of the field 140. The graph 598 represents a subsurface assessment using a deterministic physical description of what are reasonably certain factors. Multiple working hypotheses may be applied to develop representative physical descriptions of what the field 140 could be. In this example, the area of interest (AOI) and oil water contact (OWC) have the highest impact. Different potential scenarios can be analyzed using models and other forms of algorithms by the example appraisal system 199. Proper evaluation may require detailed analysis, as oversimplified assumptions, such as averages, may not be enough to properly evaluate development concepts. In some cases, there may be a focus on uncertainties that can offer discrete learning opportunities. Details may be covered extensively in the subsurface uncertainty management plan (UMP) generated by the example appraisal system 199.

In step 383, an MFO objectives hierarchy is generated. The MFO objectives hierarchy may be generated using the data obtained in step 381 and/or based on characterization of the field 140 in step 382. FIG. 6 shows a graph 698 of an example hierarchy of MFO objectives for appraising the field 140. As with the graph 698 of FIG. 6, the strategic and fundamental objectives should be clearly identified. Assumptions should be challenged and tested on “needs” versus “wants”. Cross-functional disciplines should be included in the framework or hierarchy of MFO objectives. FIG. 7 shows a graph 798 of an example hierarchy of MFO objectives for appraising an example field 140 named Silver Fleece. At this stage, appraisal may not be needed. With exploration success, such action may be worth considering. “Hot-topics” objective hierarchy is recommended to include appraisal discussion. FIG. 8 shows a table 897 that lists and justifies needs, wants, and exclusions for appraising the example field 140 named Silver Fleece. The table 897 can be part of an iterative process and may be updated periodically.

In step 384, the minimum functionality case (MFC) is determined. Different guidance factors can be considered in determining the MFC. For example, a base case economic test can be used to determine if a user 151 (e.g., a company) is willing to incentivize developments in this area. For instance, projects as low as 1.4 DPI point-forward may be approved for a field 140, but the user 151 may want to see some sensitivities. As another example, a downside test for development of the field 140 may be assessed. In such a case, if the EUR is the highest uncertainty, the user 151 may want to see if a recommended development concept could still break even (1.0 DPI point-forward) in a P10 EUR outcome (resilience). As yet another example, high outcome scenarios of the field 140 may be generated, where the high side of the curve may uncover high-value and low-cost pre-investment opportunities that could be overlooked if the user 151 does not consider high subsurface outcomes, therefore, also test concepts at the P90 EUR. To be competitive in the portfolio, a project should be profitable more often than not.

FIG. 9 shows a graph 998 of an example of a topographical map of part of a field 140 used to determine the MFC. A goal of this step using the appraisal system 199 is to find the lowest cost solution in developing the field 140 that meets the essential objectives identified in the objectives hierarchy. This step may include assuming P50 properties and maps to identify the P50 EUR/well, and using the results for screening economics. This step may also include plotting development concepts on an investment efficiency chart to understand benefit-cost ratios. This step may also include understanding the portfolio fit and competitiveness for this area, business unit, and/or basin to define the minimum acceptable risk-adjusted returns. This step may also include understanding where an MFC candidate (including well count) fits on a field EUR S-curve to assess investment worthiness. This step may also include testing for the probability of achieving returns that are acceptable with an investor mindset, as referenced in the graph 1098 of FIG. 10, which shows an example of a plot of a risk-reward spectrum.

Specifically, the graph 1098 of FIG. 10 designates an area for an investor mindset, a developer mindset, and a gambler mindset. The investor mindset is characterized by an increase in the likelihood of high performance, a reduction in the probability of overbuilding, and allowing for staging and earning as lessons are learned in development of the field 140. The developer mindset is characterized by decision makers focused on maximizing profit with managed risk. The gambler mindset is characterized by disregarding probabilities, focusing on maximum profits, and risking that development opportunities have a higher probability of underperforming.

FIGS. 11 and 12 show graphs related to a point in time where there may be exploration success, but also where there may be little or no appraisal information for MFC identification. Specifically, FIG. 11 shows a graph 1198 of an example of a topographical map of an area of interest for a field 140 corresponding to the graph 1198 of FIG. 11 used to determine the MFC. FIG. 12 shows a graph 1298 of an example S-curve plotting exploration success along the vertical axis versus projected estimated ultimate recovery (EUR) along the horizontal axis. The full resource distribution shows the P10, P50, and P90 scenarios along the plot in FIG. 12. The pre-appraisal s-curve shown in FIG. 12 may include all known risks and uncertainties, measured in terms of resources. Using a full range of EUR may be useful to understand the potential recovery of the field 140 if the field 140 is fully developed.

FIGS. 13 and 14 show graphs related to a point in time where different well counts and locations are modeled for MFC identification. Specifically, FIG. 13 shows a graph 1398 of an example of a topographical map of an area of interest for a field 140 corresponding to the graph 1398 of FIG. 13 used to determine the MFC. FIG. 14 shows a graph 1498 of an example S-curve plotting exploration success along the vertical axis versus projected EUR along the horizontal axis. The MFC concept may be bottom-up focused, starting with a high confidence area within the confined channel polygon of FIG. 13. Assumptions may include only primary depletion and tieback to a host. For the graph 1498 of FIG. 14, different well counts are tested and plotted on the S-curve. For screening purposes, the EV is not plotted. Rather, single points are plotted for each scenario that represent P50 deterministic estimates for everything except field EUR.

The goal in this activity is to find the lowest cost solution that meets essential objectives. In this step, P50 properties may be assumed and mapped to identify P50 EUR/well and use it for screening economics. Results may be plotted on an investment efficiency chart to understand the BC ratio. In order to understand portfolio fit and competitiveness for this area, a user 151 and/or the basin may define minimally acceptable risk-adjusted returns. A resilience test of this step may be to understand where an MFC candidate (including well count) fits on the field s-curve (e.g., the graph 1498 of FIG. 14) to assess investment worthiness. A goal of this step may be to identify an MFC candidate with an acceptable profit probability.

FIGS. 15 through 18 show graphs that show various plots related to determining the MFC, starting with the evaluation of a one-well tieback development. As only one well fails to meet the DE guidance of 1.4 DPI, more wells are added until certain criteria are met. The 3-well case meets the 1.4 DPI criterion at a P19 EUR, which is in the investor mindset portion of the curve of FIG. 10 and is carried forward as an MFC candidate for the additional tests. The graph 1598 of FIG. 15 shows an example of an investment efficiency chart used to help determine the MFC. The graph 1698 of FIG. 16 shows an example of the estimated production over time in the 3-well case. The graph 1798 of FIG. 17 shows an example of the estimated capital expenditure to develop the 3-well case over time. The graph 1898 of FIG. 18 shows an example of the estimated net cash flow associated with the 3-well case over time.

In step 385, a determination is made as to whether resiliency of the MFC determined in step 384 should be tested. If the resiliency of the MFC determined in step 384 should not be tested, the process reverts to step 384. If the resiliency of the MFC determined in step 384 should be tested, the process proceeds to step 386. While the Oil-in-Place assessment does not change with changes in development concept, the recovery factor can change significantly, affecting the EUR potential. Some reasons for reduced recovery factors may include, but are not limited to, the recovery method (e.g., primary vs. waterflood), the inability to access all parts of the field 140, facility life, lease term constraints, facility impact on wellhead pressures, flow assurance constraints from flowlines, and project economic life. Testing resiliency can include understanding the impact of a low outcome scenario and how to capture additional upside.

FIG. 19 shows a graph 1998 of an example of plotting an incremental evaluation. In the graph 1998, each MFC and enhancement case is tested at a low (resilience, P10) and high (upside, P90) subsurface outcome. Testing the upside can be done to help understand the value of flexibility or pre-investment to capture the upside. In such cases, staging may be considered to provide flexibility of each development concept. FIG. 20 shows a graph 2098 of an example of plotting a resilience test for a base MFC candidate and an enhanced MFC candidate. Subsurface assessments for appraisal planning may be unbiased and tuned to the development alternatives being considered for the project. Each enhancement may be tested on a low subsurface outcome (P10, represented by the lowest data point within each vertical range box shown in the graph 1998) to understand the economic impact of the uncertainty range. Testing for the upside (P90, represented by the triangle at the top of each vertical range box shown in the graph 1998) can help identify potential value accretive flexibility and/or staging opportunities.

Although the tieback passed the P10 resilience test in this example, staging the project may defer capital expenditure (CAPEX) until information from the initial well(s) is available. This makes the MFC candidate even more resilient but requires robust signposting. This analysis focuses on the subsurface P10 EUR downside, but other uncertainties (e.g., capex, opex, commercial terms, etc.) may be more impactful for the specific project and may also be tested for resilience. The s-curve for resilience test shown in FIG. 20 may be impacted by the development concept. The smaller the development concept and/or the number of wells, the greater the difference between what may be recovered with this concept and the full developable resources s-curve.

FIG. 21 presents a graph 2198 of an example of plotting a s-curve showing a resilience test for a 3-well MFC candidate with a P10 subsurface outcome. FIG. 22 shows a table 2296 listing data output from the resilience test for the MFC candidate plotted in FIG. 21. Resilience depends on the project's main risks and uncertainties and other variables may be required depending on the case. Resilience relative to capital (wells/facilities costs) or commercial risks are not tested in this example for the sake of simplicity. Although the project is resilient at the P10 field outcome, there is a gap in this example in years for when the wells are developed. As a result, staging the wells may allow the development to be even more resilient.

FIG. 23 shows a graph 2398 of an example of plotting a s-curve showing a resilience test for a 3-well tieback MFC candidate with a development concept alternative relative to what is shown in FIG. 21. FIG. 24 shows a table 2496 listing example data output from the resilience test for the MFC candidate plotted in FIG. 23. The three-well tieback meets the DE's decision criteria and is resilient at the P10 outcome. Sensitivities to factors such as CAPEX, commercial terms, etc., may be tested to understand their impact on the effectiveness of the 3-well tieback MFC candidate. In some cases, the 3-well tieback MFC candidate may be tested and plotted in a P90 outcome scenario to evaluate upside flexibility.

FIG. 25 shows a graph 2598 of an example plotting a s-curve showing a resilience test for the tieback MFC candidate in a P90 unconstrained scenario to capture upside by adding more wells. FIG. 26 shows a graph 2698 of an example plotting a s-curve showing a resilience test for a 2-well tieback MFC candidate with 3 wells forward in a P90 unconstrained scenario. With MFC downside testing complete, flexibility to monetize the upside is evaluated to better understand constraints. Contract term and host facility capacity limits may make development concepts with six wells or more to be less economic than smaller developments. Additionally, for this activity in the workflow, median of EUR/well and IP are used in this example. By looking deterministically to the upside, the analysis does not overlook minimal pre-investments that could be a requirement in pursuing the upside scenario. Also, this analysis may act as a screening discussion tool as to what actions could be taken when pursuing the upside scenario. In some cases, the enhancement may be limited to adding more wells or debottlenecking the facility, as a second stage may be too much. Running scenarios for MFC candidates as to the upside may help uncover some minimum pre-investments that may be economically desirable. Such an assessment does not invalidate the MFC but rather identify enhancements that could benefit the development of the upside.

Resilience tests may follow economic guidance (e.g., exceed 1.4 DPI) provided by a user 151. The example appraisal system 199 may eventually provide a recommended MFC candidate based on analyzing and comparing the various scenarios that are run. The MFC candidate in this example is within the high-confidence range of the EUR s-curve. Though MFC candidate can withstand the downside of a P10 subsurface outcome, staging the project with one or two wells further protects the project from the low side and does not jeopardize the upside.

In step 386, one or more enhancements are analyzed. In certain example embodiments, an enhancement is a deterministic case that is more capital intensive than the MFC candidate. An enhancement also meets defined objectives and may be value accretive when compared to the MFC candidate. FIGS. 27 and 28 show graphs related to analyzing an enhancement. Specifically, FIG. 27 shows a graph 2798 of an example of a topographical map of an area of interest for a field 140. FIG. 28 shows a graph 2898 of an example S-curve plotting deterministic evaluations of enhancements (FPU case). In this example, the enhancement is a deterministic case that is more capital intensive than the MFC, meets defined objectives, and can be value accretive when compared to the MFC. For the first enhancement in this case, installation of a floating production unit (FPU) with up to four wells is tested.

Test project enhancements may range from small additions to entirely different concepts. The process of analyzing enhancements may include assessing incremental economics to the MFC and/or a previous enhancement to understand the value gained from the additional capital required for the enhancement. In some cases, P50 properties may be assumed and mapped to identify P50 EUR/well and use the information for screening economics. Understanding where the enhancement candidate (which includes well count) fits on a field s-curve (as in FIG. 28) may be used to assess investment worthiness (e.g., is the probability of being profitable acceptable?).

FIGS. 29 through 32 show graphs that show various plots related to analyzing enhancements (no appraisal). For the five-well case, the FPU is value accretive over the tieback case and is within the investor mindset portion of the curve of FIG. 10. The graph 2998 of FIG. 29 shows an example of an investment efficiency chart used to analyze the enhancement. The graph 3098 of FIG. 30 shows an example of the estimated production over time for the enhancement. The graph 3198 of FIG. 31 shows an example of the estimated capital expenditure for the enhancement over time. The graph 3298 of FIG. 32 shows an example of the estimated net cash flow associated with the enhancement over time.

In step 387, potential appraisal activities are identified. Identifying potential appraisal activities may help a user learn about key project risks and uncertainties. In some cases, identifying potential appraisal activities may help determine whether the enhancement identified in step 386 is resilient. If the enhancement identified in step 386 is not resilient (e.g., fail the resiliency test), then there may be a determination to understand if an appraisal can provide information to either reject an enhancement candidate or to make it resilient. In step 388, the lowest cost appraisal activity to the desired learning may be determined.

FIGS. 33 through 35 are directed to an example of an enhancement tested for resiliency. Specifically, FIG. 33 shows a graph 3398 of an example of a s-curve for testing the resiliency of an enhancement. FIG. 34 shows a graph 3498 of an example of a s-curve for exploration success of development concept alternatives of the enhancement. The table 3596 of FIG. 35 shows example data related to testing the resiliency of the enhancement, where the checkmarks indicate resilience and the “X” at the top of the Field Resilience column indicates an absence of resilience.

The tests captured in the examples shown in FIGS. 33 through 35 are directed to a P10 subsurface outcome of the enhancement. The s-curve in FIGS. 33 and 34 shows the EUR range for this example enhancement. In this case, resilience is being tested at P10 EUR for a four-well FPU. Resilience relative to capital (e.g., wells, facilities, costs) and/or commercial risks may also be tested. In some cases, avoidable costs may be excluded in a resilience test (e.g., if signposts indicate, later wells can be excluded). As shown in FIGS. 33 through 35, the test of the enhancement for the downside (P10) is not resilient on the current resource curve. Appraisal, however, could potentially shift that curve.

In some cases, it may be worthwhile to understand the relative ability of the enhancement to monetize the upside (P90) compared to the MFC. In this example, the enhancement is being tested by adding more wells only, but different concepts might be considered with other opportunities. FIG. 36 shows a graph 3698 of an example plotting a s-curve capturing an upside (P90) of an enhancement to the MFC by adding more wells. FIG. 37 shows a graph 3798 of an example plotting a s-curve capturing an upside (P90) of an enhancement to the FPU30 case by adding more wells. Sometimes an enhancement may be limited to adding more wells or debottlenecking the facility, because a second stage or a new host facility may be too much. In any case, early discussion on the upside (e.g., P90) may help uncover some minimum pre-investments that may be economically desirable. In the case of tiebacks, debottlenecking opportunities may be evaluated to understand the capabilities of the existing host facility.

FIG. 38 shows a graph 3898 with multiple plots of example investment efficiency for an enhancement. FIG. 39 shows a graph 3998 with multiple plots of example enhancements using incremental value analysis. Both the tieback and the FPU have competitive incremental economics for each additional well on a deterministic basis, for up to five wells. Beyond five wells, the tieback case is constrained. Enhancement #1 (FPU) in this example is value accretive at five wells and above, but lacks resilience to the downside as shown in the table 4196 of FIG. 41.

FIG. 40 shows a graph 4098 of an example of a s-curve related to resiliency tests for an enhancement. The table 4196 of FIG. 41 shows example data related to resiliency tests for the enhancement, where the checkmarks indicate resilience and the “X” toward the top of the Field Resilience column indicates an absence of resilience. As a result of the data shown in FIGS. 40 and 41, the proposed enhancement may not be recommended. In an example where the proposed enhancement includes FPU30 with four or five wells in a no appraisal case, the resilience test fails, but the FPU seems to offer value in an upside resource outcome. Evaluating an appraisal in this case may be warranted to reduce risk. While the FPU enhancement seems justified deterministically, downside risk should not be disregarded, and testing the appraisal value may be an appropriate next step.

In step 389, the appraisal value is assessed. An effective appraisal requires a clear understanding of the MFO-derived development alternatives. MFO assessment starts with the lowest cost viable investment and justifies any additional investments. Appraisal may be a learning activity where the justification comes from creating value within a value of information framework. In such a case, VOI may be based on the entire S-curve instead of the expected value (EV) only, which allows a decision to be made based on the entire range of outcomes. To assess the appraisal value, an understanding may be needed as to what uncertainties would be addressed and the learning activities that can be used to do so. When step 389 is complete, the process proceeds to the END step.

In most cases, the cost of the entire appraisal program required for an associated development concept may be included in the evaluation, not just the current appraisal operation. The value of the information framework developed by the example appraisal system 199 may be measured by the incremental value of changing (e.g., improving) an investment decision. The units of measure for “value” may be defined by a user 151 and may be a capital efficiency measure. The value of the information framework developed by the example appraisal system 199 may be risked by the likelihood of getting an improved decision from the learning activity. The value of the information framework developed by the example appraisal system 199 may include the cost and schedule impact of the learning activity.

The uncertainty management plan and appraisal planning may include multiple steps. An example of one such step may be or include characterizing the asset. In such a case, this step may include, but is not limited to, reviewing uncertainty ranges that go into the exploration resource range and make updates with exploration well lessons learned, assessing ranges for dynamic and other uncertainties not captured in the exploration resource assumptions, and ranking contribution of component uncertainties to overall resource uncertainty. An example of another such step may be or include linking uncertainties to decisions. In such a case, this step may include, but is not limited to, identifying development decisions that may change based on additional learning for each uncertainty. When the learning from the uncertainties has the potential to change a decision, there may be value of information (VOI).

An example of yet another such step may be or include identifying resolution options. In such a case, this step may include, but is not limited to, listing learning activities that could help reduce a range for each uncertainty, and assessing the cost of resolution options in terms of both cost and project delay. In the latter case, the relative costs and timing of appraisal may be included in analysis by comparing them to moving forward without appraisal. An example of yet another such step may be or include assessing effectiveness of an appraisal value. In such a case, this step may include, but is not limited to, assessing indicators that may be monitored with clear definitions of boundaries between them, and assessing residual uncertainty remaining after obtaining each indicator, which may be affected by factors that can include, but are not limited to, a range of uncertainty within the boundaries of each indicator, the risk of incorrectly interpreting the indicator, the risk of false indicators (positive and negative), and representativeness of the indicator of the field 140.

In assessing the appraisal value, the example appraisal system 199 may provide answers to one or more issues, including but not limited to identifying how additional information changes investment decisions, identifying the key subsurface uncertainties that affect investment decisions, identifying how much learnings may change after an appraisal, and identifying the lowest cost appraisal alternatives to resolve uncertainties (e.g., appraisal MFC). Examples of key risks and uncertainties that may be considered by the example appraisal system 199 may include, but are not limited to, depositional environment (e.g., NTG, OOIP, area) of the field, OWC (e.g., area, OOIP), permeability (e.g., rate, RE), lateral communication (e.g., OOIP, rate), and viscosity (e.g., rate, RE).

As part of assessing the appraisal value, the example appraisal system 199 may generate one or more tables, such as the table 4296 of FIG. 42. In the case of the table 4296 of FIG. 42, well B may be located to prove/disprove the minimum volume to justify enhancement addressing the main uncertainties of channel vs. sheet and OWC. Further, wells A and C are located to prove the sheet deposition in an up-dip area (test upside). In addition, well D is located to prove the sheet deposition in a down-dip area (test upside). Further, well E is meant to test deep OWC in the high confidence area.

FIG. 43 is another example of a table 4396 generated by the example appraisal system 199. Accompanying the table 4396 are the graph 4498 or FIG. 44 and the graph 4598 of FIG. 45. The graph 4498 of FIG. 44 shows a sectional view of part of the field 140 in a low outcome scenario, and the graph 4598 of FIG. 45 shows a sectional view of the same part of the field 140 shown in FIG. 44 in a high outcome scenario. In this example, location B is selected using the method discussed above. This selection may prove in the high case that the depositional system was not a confined channel, and the oil-water contact may not be the shallow case. Outcomes of “B” well may clearly differentiate development decisions, as shown by the graph 4698 of FIG. 46 and the graph 4798 of FIG. 47. If supplement appraisal activities associated with each appraisal well outcome scenario are required, the incremental cost/schedule associated with supplemental appraisal activity should be included in the economic assessment.

Continuing with this example, outcomes of the “B” appraisal well may be consolidated in two main scenarios. The first main scenario is an appraisal “low” indicator, corresponding to the graph 4498 of FIG. 44, with a 27% chance of occurrence. In this scenario, well B sees no reservoir or oil, and so the interpretation may be that the reservoir is likely channelized. The second main scenario is an appraisal “high” indicator, corresponding to the graph 4598 of FIG. 45, with a 73% chance of occurrence. In this scenario, well B sees good reservoir sand with log characteristics that indicate a sheet environment, oil may be filled to the base of the reservoir, and pressures indicate likely connectivity with the exploration well in the field 140.

Graph 4898 of FIG. 48 and graph 4998 of FIG. 49 show example s-curves for DPI point forward and DPI FEED forward, respectively, for the appraisal “low” indicator of well B. In this example, on a point-forward basis, recovering the investment (DPI>1) happens at the P15 of the resource S-curve, outside of the P10 high-confidence range. Additionally, this example development concept on a point-forward basis with appraisal does not reach the minimum economic case of 1.4 DPI. On a FEED-forward basis, it is unlikely that this project scope would be developed as the minimum expected economics is reached at P57. At times, it may be more capital efficient to exit/divest than to appraise and develop in this “low” case. Other considerations may include, but are not limited to, the value of the project without appraisal, the downside that could be revealed in an appraisal low outcome, and the upside could be revealed in an appraisal high outcome.

Graph 5098 of FIG. 50 and graph 5198 of FIG. 51 show example s-curves for DPI point forward and DPI FEED forward, respectively, for the appraisal “high” indicator of well B. In this example, appraisal scenarios include the appraisal well cost and the project delay for the appraisal well and interpretation of results. Further, on a point-forward basis, the project reaches minimum economic requirement by P40 and starts recovering the investment (DPI>1) on the P8, inside the high-confidence range (resilience test). On a FEED-forward basis, the project is robust in terms of required economics, reaching DPI of 1.24 within the high-confidence range and reaching an investable case in the P25.

A screening test compares a decision with no information about uncertainties to the decisions if those uncertainties were known (perfect information). With no additional information about the key uncertainties (e.g., low/high subsurface outcome), economics may indicate a tieback development is justified due to resilience in the low-case outcome. If uncertainties were fully understood before a concept decision, economics may change the concept recommendation depending on the outcome. In the “low” case, the outcome may drive a decision to consider “walking away,” while the “high” appraisal indicator may drive a recommendation for FPU development. In this example, based on the perfect information screening evaluation, there may be value in continuing the analysis with imperfect information and understanding whether or not there is value in appraising. An imperfect indicator occasionally points in the wrong direction. For example, with an appraisal “high” result, there may still be a 15% chance of a low-subsurface outcome.

The graph 5298 of FIG. 52 shows an example of a s-curve for a base case alignment no-appraisal decision plotting cumulative probability along the vertical axis versus DPI along the horizontal axis. The graph 5398 of FIG. 53 shows an example of a s-curve for the base case alignment no-appraisal decision plotting cumulative probability along the vertical axis versus NPV10 ($MM) along the horizontal axis. The graph 5498 of FIG. 54 shows an example of a s-curve for the base case alignment no-appraisal decision plotting cumulative probability along the vertical axis versus VC1.4 ($MM) along the horizontal axis. The graph 5598 of FIG. 55 shows an example of a s-curve for the base case alignment no-appraisal decision plotting cumulative probability along the vertical axis versus VC1.8 ($MM) along the horizontal axis.

The graph 5698 of FIG. 56 shows an example of a s-curve for a base case alignment no-appraisal decision plotting cumulative probability along the vertical axis versus DPI along the horizontal axis. The graph 5798 of FIG. 57 shows an example of a s-curve for the base case alignment no-appraisal decision plotting cumulative probability along the vertical axis versus NPV10 ($MM) along the horizontal axis. The graph 5898 of FIG. 58 shows an example of a s-curve for the base case alignment no-appraisal decision plotting cumulative probability along the vertical axis versus VC1.4 ($MM) along the horizontal axis. The graph 5998 of FIG. 59 shows an example of a s-curve for the base case alignment no-appraisal decision plotting cumulative probability along the vertical axis versus VC1.8 ($MM) along the horizontal axis.

The graph 6098 of FIG. 60 shows an example of a s-curve for a base case alignment no-appraisal decision plotting cumulative probability along the vertical axis versus DPI along the horizontal axis. The graph 6198 of FIG. 61 shows an example of a s-curve for the base case alignment no-appraisal decision plotting cumulative probability along the vertical axis versus NPV10 ($MM) along the horizontal axis. The graph 6298 of FIG. 62 shows an example of a s-curve for the base case alignment no-appraisal decision plotting cumulative probability along the vertical axis versus VC1.4 ($MM) along the horizontal axis. The graph 6398 of FIG. 63 shows an example of a s-curve for the base case alignment no-appraisal decision plotting cumulative probability along the vertical axis versus VC1.8 ($MM) along the horizontal axis.

In this example, appraisal adds value by identifying either the channel or sheet deposition, allowing the selection of the FPU in the sheet outcome and exit in the channel outcome. Appraisal may ensure that the cost of the full program is incorporated. An appraisal may help a user 151 understand the impact of a range of outcomes on the various cases (e.g., MFC, enhancements). Risks and uncertainties may go beyond the subsurface (e.g., cost, schedule, commercial). Multiple decisions may be blended into a combined s-curve reflecting the appraisal outcomes. The VOI may be calculated for each appraisal strategy under consideration.

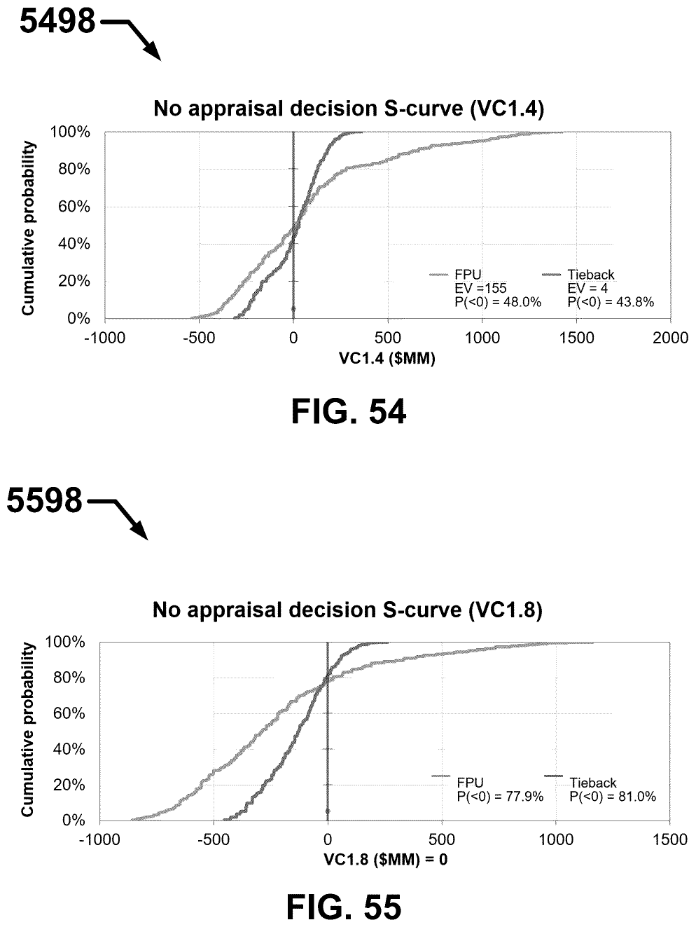

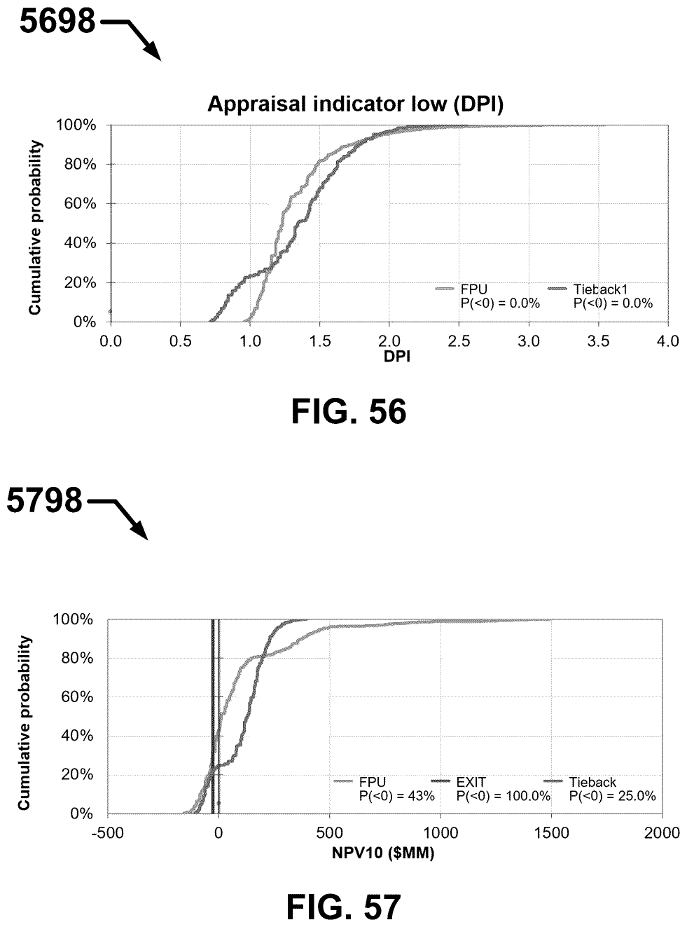

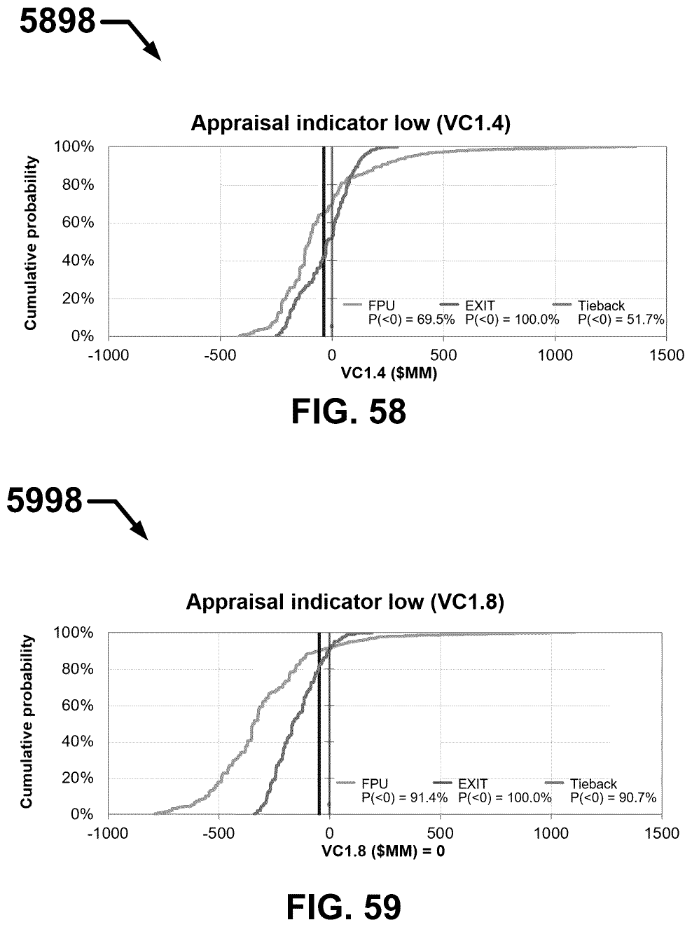

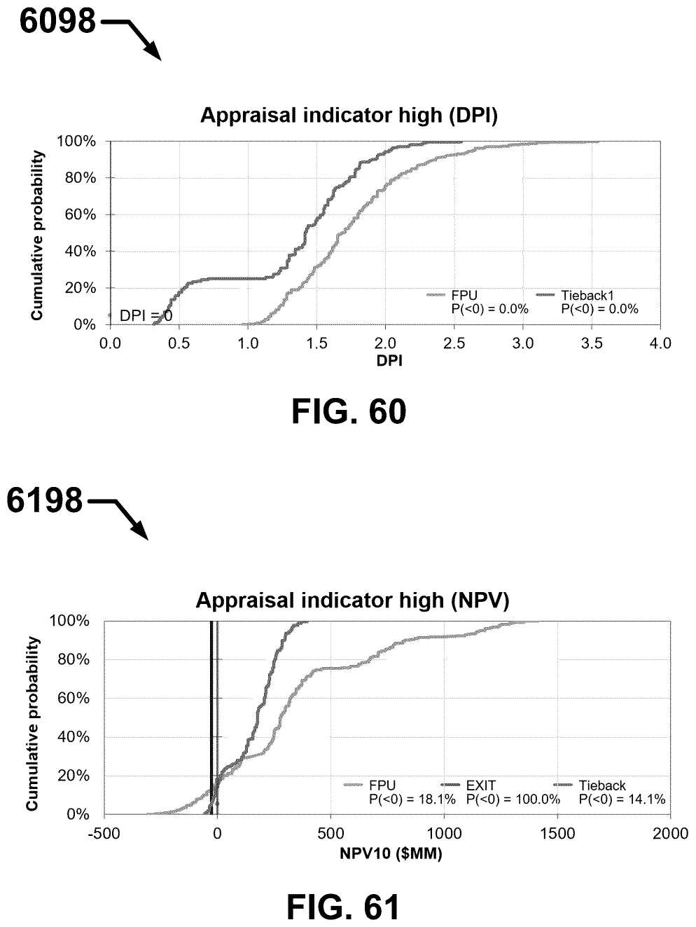

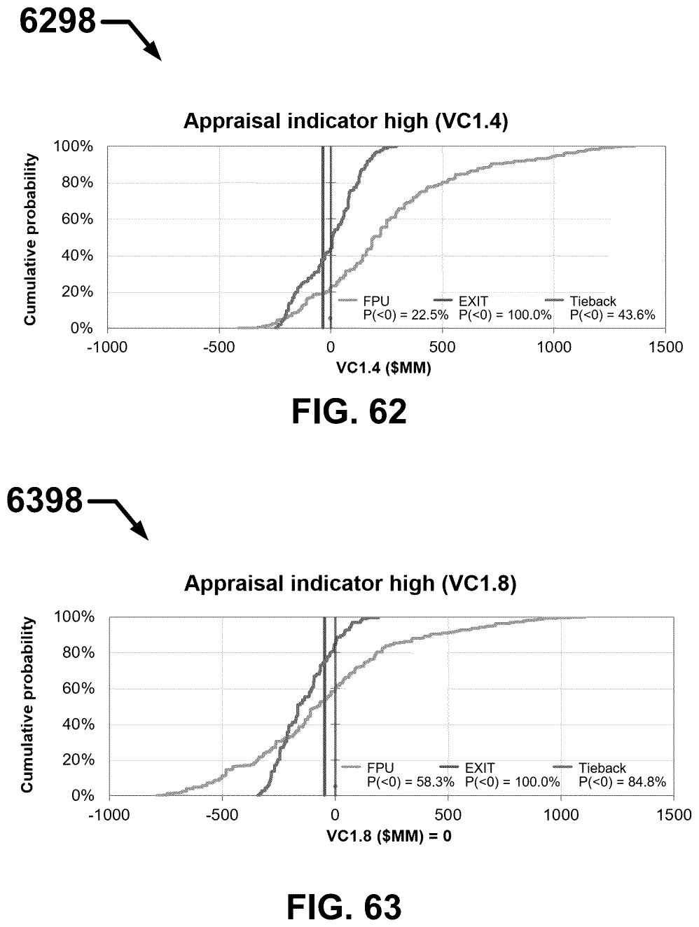

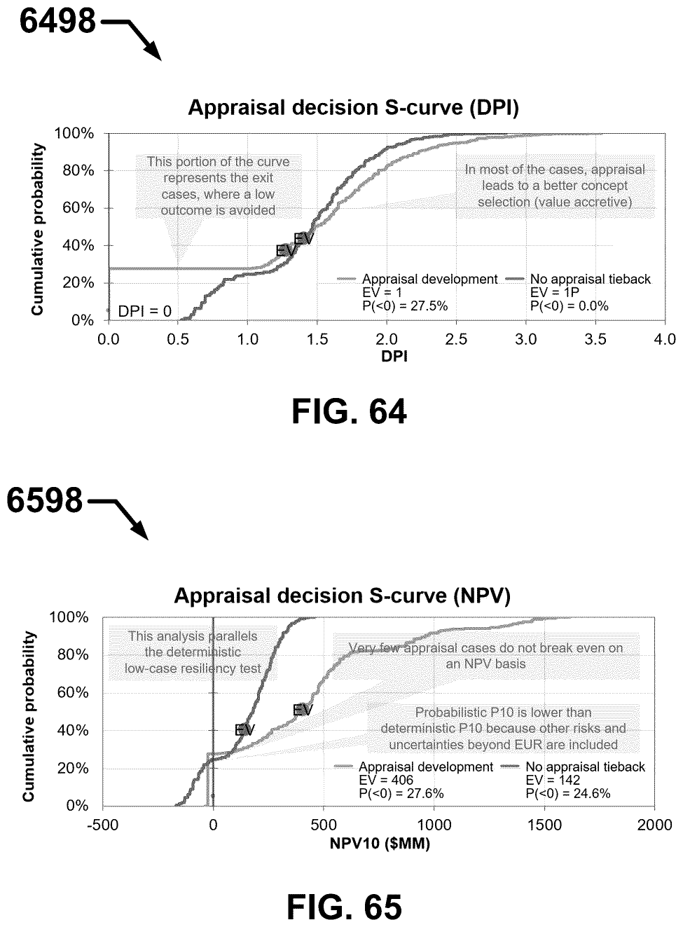

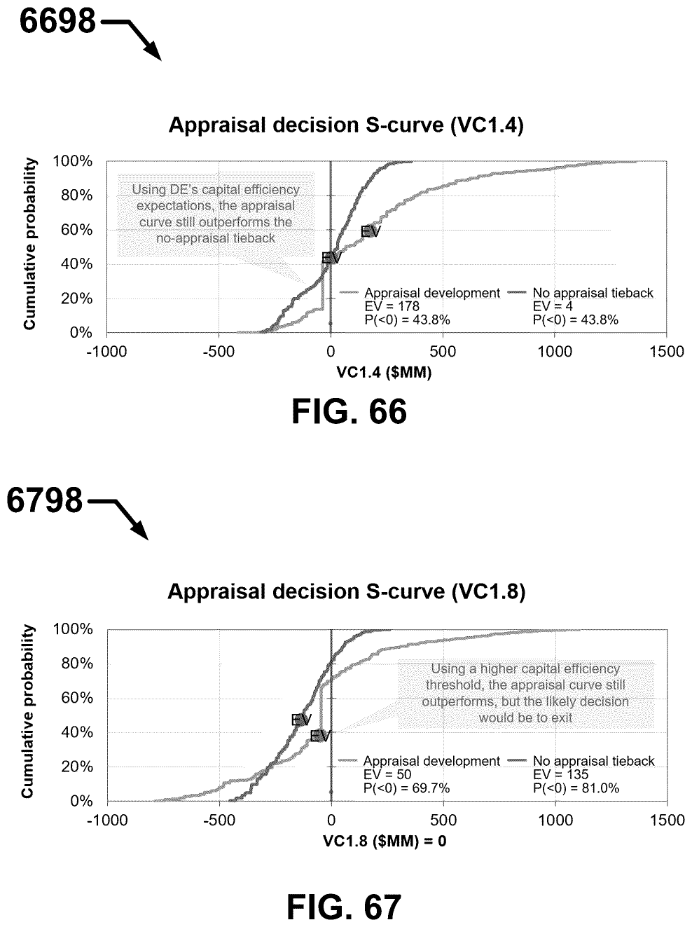

The graph 6498 of FIG. 64 shows an example of a s-curve for an appraisal evaluation using imperfect information plotting cumulative probability along the vertical axis versus DPI along the horizontal axis. The graph 6598 of FIG. 65 shows an example of a s-curve for the appraisal evaluation using imperfect information plotting cumulative probability along the vertical axis versus NPV10 ($MM) along the horizontal axis. The graph 6698 of FIG. 66 shows an example of a s-curve for the appraisal evaluation using imperfect information plotting cumulative probability along the vertical axis versus VC1.4 ($MM) along the horizontal axis. The graph 6798 of FIG. 67 shows an example of a s-curve for the appraisal evaluation using imperfect information plotting cumulative probability along the vertical axis versus VC1.8 ($MM) along the horizontal axis.

Appraisal using example embodiments may be designed to support development decisions. Deterministic screening using example embodiments may be useful in identifying the MFC and enhancement and potential appraisal opportunities. Probabilistic appraisal evaluation using example embodiments may reveal opportunities to improve value through upside capture or downside avoidance. Probabilistic evaluation for each development concept using example embodiments may include the development response to the full range of resource outcomes (e.g., adding wells, staging, etc.) Value added from appraisal using example embodiments may be in excess of the appraisal cost, both in dollars and time. The highest value accretion in this case may result from appraising using example embodiments.

Example embodiments allow for appraisal evaluation tied to Capital Projects Operating Model for Opportunity Shaping, using MFO, starting with the MFC. Appraisal economic evaluation using example embodiments provides an appraisal for a full program, not individual spend activities. Example embodiments allow for incorporating resilience test for downside outcomes and upside flexibility test (e.g., staging) to understand the value of capturing the upside later, if present to understand trade-offs. Example embodiments allow for moving away from EV decision making and evaluating decisions based on S-Curves (value of information), while mindful of the investor mindset. Example embodiments allow for reinforcement of other risks and uncertainties beyond the subsurface in the evaluation (e.g., cost, schedule, commercial, etc.).

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. A computer-implemented method for applying a minimum functional objectives (MFO) framework for upstream appraisal investment decisions, the method comprising:
obtaining data;
characterizing a field based on the data;
generating an MFO objectives hierarchy based on characterizing the field;
determining a minimum functionality case based on generating the MFO objectives hierarchy;
analyzing an enhancement derived from the minimum functionality case;
identifying potential appraisal activities to learn about key project risks and uncertainties;
determining the lowest cost appraisal activity to the desired learning; and
assessing an appraisal value of the enhancement.

2. An appraisal system comprising:
a controller configured to:
obtain data;
characterize a field based on the data;
generate a minimum functional objectives (MFO) objectives hierarchy based on characterizing the field;
determine a minimum functionality case based on generating the MFO objectives hierarchy;
analyze an enhancement derived from the minimum functionality case;
identify potential appraisal activities to learn about key project risks and uncertainties;
determine the lowest cost appraisal activity to the desired learning; and
assess an appraisal value of the enhancement.
